(19) United States
(12) Patent Application Publication
(10) Pub. No.: US 2025/0117765 A1
(43) Pub. Date: Apr. 10, 2025

(54) AUTOMATIC ITEM IDENTIFICATION DURING ASSISTED CHECKOUT

(71) Applicant: RadiusAI, Inc., Tempe, AZ (US)

(72) Inventors: Abhinav Yarlagadda, Woodinville, WA (US); Enis Dengi, Tempe, AZ (US); Sai Krishna Bashetty, Bellevue, WA (US); Rahul Santhosh Kumar Varma, Tempe, AZ (US); Daniel King, Seattle, MA (US); Kamalesh Kalirathinam, Tempe, AZ (US); Nathan Kelly, Phoenix, AZ (US); Sri Priyanka Madduluri, Arlington, VA (US); Thomas Strich, Tempe, AZ (US)

(21) Appl. No.: 18/906,556

(22) Filed: Oct. 4, 2024

Related U.S. Application Data
(60) Provisional application No. 63/587,874, filed on Oct. 4, 2023.

(51) Int. Cl. G06Q 20/20

(52) U.S. Cl. CPC G06Q 20/203; G06Q 20/208

(57) ABSTRACT

Systems and methods include extracting item parameters from images of items positioned at a POS system. UPC features included in the item parameters associated with each item when combined are indicative as to an indication of the UPC of each item. The UPC features are analyzed to determine whether the UPC features associated with each item when combined match a corresponding combination of UPC features stored in a database. The database stores different combinations of UPC features with each different combination of UPC features associated with a corresponding item thereby identifying each corresponding item based on each different combination of UPC features associated with each item. Each item positioned at the POS system is identified when the UPC features associated with each item when combined match a corresponding combination of UPC features as stored in the database.

### CROSS-REFERENCE TO RELATED APPLICATIONS

The present application is a U.S. Nonprovisional Patent Application which claims the benefit of U.S. Provisional Application No. 63/587,874, filed on Oct. 4, 2023 which is incorporated herein by reference in their entirety.

### BACKGROUND

Retailers often incorporate self-checkout systems at the Point of Sale (POS) in order to decrease the wait time of customers to have their selected items scanned and purchased at the POS. Self-checkout systems also reduce the footprint required for the checkout systems as assisted checkout systems require less footprint than traditional checkout systems that are staffed with a cashier. Self-checkout systems also reduce the quantity of cashiers required to staff the self-checkout systems as one or two cashiers may be able to manage several self-checkout systems rather than having a cashier positioned at every checkout system.

Self-checkout systems require the customer to scan one selected item for purchase at a time once positioned at the POS for items which have a Universal Product Code (UPC) which is scanned by the customer at the POS thereby identifying the item based on the scanned UPC. Selected items for purchase that do not have a UPC require the customer to then navigate through the self-checkout system to type in the name of the item without a UPC and then select the item in that manner. Errors often happen in which an item was not properly scanned and/or properly identified causing the self-checkout system to pause and require intervention by the cashier. Conventionally, self-checkout systems require intense interaction by the customer to essentially execute the checkout of the items by themselves. Self-checkout systems also increase the wait time for customers to checkout due to the pausing of the self-checkout systems and requiring the intervention of the cashier before continuing with the checkout process.

### BRIEF SUMMARY

Embodiments of the present disclosure relate to providing a point of sale (POS) system that automatically identifies items positioned at the POS for purchase based on images captured of the items by cameras positioned at the POS as well as cameras positioned throughout the retail location. A system may be implemented to automatically identify a plurality of items positioned at a POS system based on a plurality of item parameters associated with each item as provided by a plurality of images captured by a plurality of cameras positioned at the POS system. The system includes at least one processor and a memory coupled with the at least one processor. The memory includes instructions that when executed by the at least one processor cause the processor to extract a plurality of Universal Product Code (UPC) features included in a plurality of item parameters associated with each item positioned on the POS system from the plurality of images captured of each item by the plurality of cameras positioned at the POS system. The UPC features associated with each item when combined are indicative as to an identification of the UPC of each item. The processor is configured to analyze the UPC features associated with each item positioned at the POS system to determine whether the UPC features associated with each item when combined matches a corresponding combination of the UPC features stored in an item parameter identification database. The item parameter identification database stores different combinations of UPC features with each different combination of UPC features associated with a corresponding item thereby identifying each corresponding item based on each different combination of UPC features associated with each item. The processor is configured to identify each corresponding item positioned at the POS system when the UPC features associated with each item when combined match a corresponding combination of UPC features as stored in the item parameter identification database.

In an embodiment, a method automatically identifies a plurality of items at a Point of Sale (POS) system based on a plurality of item parameters associated with each item as provided by a plurality of images captured by a plurality of cameras positioned at the POS system. A plurality of Universal Product Code (UPC) features included in a plurality of item parameters associated with each item positioned on the POS system may be extracted from the plurality of images captured of each item by the plurality of cameras positioned at the POS system. The UPC features associated with each item when combined are indicative as to an identification of the UPC of each item. The UPC features associated with each item positioned at the POS system may be analyzed to determine whether the UPC features associated with each item when combined matches a corresponding combination of the UPC features stored in an item parameter identification database. The item parameter identification database stores different combinations of UPC features with each different combination of UPC features associated with a corresponding item thereby identifying each corresponding item based on each different combination of UPC features associated with each item. Each corresponding item positioned at the POS system may be identified when the UPC features associated with each item when combined match a corresponding combination of UPC features as stored in the item parameter identification database.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 depicts an illustration of an item identification configuration for identifying items positioned at a POS system based on item parameters associated with the item;

FIG. 2 shows an illustration of a perspective view of an example item identification configuration;

FIG. 3 depicts an illustration of an example system of item identification;

FIG. 4 depicts an illustration of a flow diagram of an example method for item identification; and

FIG. 5 depicts an illustration of a flow diagram of an example method for item identification.

### DETAILED DESCRIPTION

Embodiments of the disclosure generally relate to providing a system for assisted checkout in which items positioned at the Point of Sale (POS) system are automatically identified thereby eliminating the need for the customer and/or cashier to scan and/or identify items that cannot be scanned manually. In an example embodiment, the customer approaches the POS system and positions the items which the customer requests to purchase at the POS system. Cameras positioned at the POS system capture images of each item and then an item identification computing device may then extract item parameters associated with each item from the images captured of each item by the cameras. The item parameters associated with each item are specific to each item and when combined may identify the item thereby enabling identification of each corresponding item. Item identification computing device may then automatically identify each item positioned at the POS system based on the item parameters associated with each item as extracted from the images captured of each item. In doing so, the customer simply has to position the items at the POS system and is not required to scan and/or identify items that cannot be scanned. The cashier simply needs to intervene when there is an issue when an item is not identified by item computing device.

However, in an embodiment, item identification computing device may continuously learn via a neural network in identifying each of the numerous items that may be positioned at the POS system for purchase by the customer. Each time that an item that is positioned at the POS system for purchase that item identification computing device does not identify, such item parameters associated with the unknown item may be automatically extracted from the images captured of the unknown by item identification computing device and provided to a neural network. The neural network may then continuously learn based on the item parameters of the unknown item thereby enabling item identification computing device to correctly identify the previous unknown item in subsequent transactions. The unknown item may be presented at numerous different locations in which item identification computing device automatically extracts the item parameters of the unknown item as presented at numerous different locations and provided to the neural network such that the neural network may continuously learn when the unknown item is presented at any retail location thereby significantly decreasing the duration of time required for item identification computing device to correctly identify the previously unknown item.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

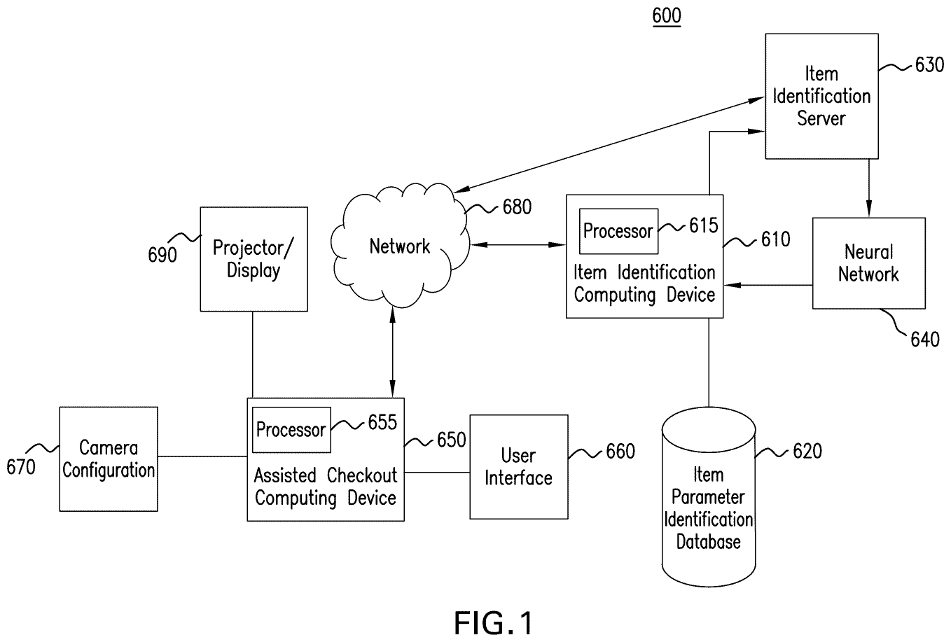

As shown in FIG. 1, an item identification configuration 600 includes an item identification computing device 610, an assisted checkout computing device 650, a camera configuration 670, a user interface 660, a projector/display 690, an item identification server 630, a neural network 640, an item parameter identification database 620, and a network 680. Image identification computing device 610 includes a processor 615. Assisted checkout computing device 650 includes a processor 655.

The checkout process, during which items intended to be purchased by a customer are identified, and prices tallied, by an assigned cashier. The term Point of Sale (POS) is the area within a retail location at which the checkout process occurs. Conventionally, the checkout process presents the greatest temporal and spatial bottleneck to profitable retail activity. Customers spend time spent waiting for checkout to commence in a checkout line staffed by a cashier where the cashier executes the checkout process and/or in a line waiting to engage a self-checkout station and completing checkout where the cashier scans the items individually and/or the customer scans the items individually in a self-checkout station.

As a result, the checkout process reduces the turnover of customers completing journeys within the retail location in which the journey of the customer is initiated when the customer arrives at the retail location and continues as the customer proceeds through the retail location, and concludes when the customer leaves the retail location. The reduction in turnover in the customers completing journeys results in a reduction of sales by the retailer as customers are simply proceeding through the retail location less and thereby reducing the opportunity for the customers to purchase items. The conventional checkout process also impedes the flow of customer traffic within the retail location and also serves as a point of customer dissatisfaction in the shopping experience, as well as posing a draining and repetitive task for cashiers. Customers also appreciate and expect human interaction during checkout, and conventional self-checkout systems are themselves a point of aggravation in the customer experience.

Item identification configuration 600 may provide a defined checkout plane upon which items are placed at the POS system for recognition by item identification computing device 610. Assisted checkout computing device 650 may then automatically list items presented at the POS system for purchase by their customer and tally the prices of the items automatically identified by item identification computing device 610. In doing so, the human labor associated with scanning the items one-by-one and/or identifying the items one-by-one may be significantly reduced for the cashiers as well as the customers. Item identification configuration 600 may implement artificial intelligence to recognize the items placed on the checkout plane at the POS system at once, even when such items may be bunched together to occlude views of portions of some of the items, and of continually improving the recognition accuracy of item identification computing device 610 through machine learning.

A customer may enter a retail location of a retailer and browse the retail location for items in which the customer requests to purchase from the retailer. The retailer may be an entity that is selling items and/or services for purchase. The retail location may be brick and mortar location and/or an on-site location that the customer may physically enter and/or exit the retail location when completing the journey of the customer in order to purchase the items and/or services located at the retail location. As noted above, the retail location also includes a POS system in which the customer may engage to ultimately purchase the items and/or services from the retail location. The customer may then approach the POS system to purchase the items in which the customer requests to purchase.

In doing so, the customer may present the items at the POS system in which the POS system includes a camera configuration 670. Camera configuration 670 may include a plurality of cameras positioned in proximity of the checkout plane such that each camera included in camera configuration 670 may capture different perspectives of the items positioned in the checkout plane by the customer. For example, the checkout plane may be a square shape and camera configuration 670 may then include four cameras in which each camera is positioned in one of the corresponding corners of the square-shaped checkout plane. In doing so, each of the four cameras may capture a different perspective of the square-shaped checkout plane thereby also capturing a different perspective of the items positioned on the checkout plane for purchase by the customer. In another example, camera configuration 670 may include an additional camera positioned above the checkout plane and/or an additional camera positioned below the checkout plane. Camera configuration 670 may include any quantity of cameras positioned in any type of configuration to capture different perspectives of the items positioned in the checkout plane for purchase that will be apparent to those skilled in the relevant art(s) without departing from the spirit and scope of the invention.

The POS system may also include assisted checkout computing device 650. Assisted checkout computing device 650 may be the computing device positioned at the POS system that enables the customer and/or cashier to engage the POS system. Assisted checkout computing device 650 may include user interface 660 such that user interface displays each of the items automatically identified as positioned at the POS system for purchase as well as the price of each automatically identified item as well as the total cost of the automatically identified item. Assisted checkout computing device 650 may also display via user interface any items that were not automatically identified and enable the cashier and/or customer to scan the unidentified item. Assisted checkout computing device 650 may be positioned at the corresponding POS system at the retail location.

One or more assisted checkout computing devices 650 may engage item identification computing device 610 as discussed in detail below in order to interface with of each of the customers and/or cashiers in real-time via user interface 660 with regard to their request for purchase of the item. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be a device that is identifying items provided to assisted checkout computing device 650 for purchase based on images captured by camera configuration 670. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be positioned at the retail location, may be positioned at each POS system, may be integrated with each assisted checkout computing device 650 at each POS system, may be positioned remote from the retail location and/or assisted checkout computing device 650 and/or any other combination and/or configuration to automatically identify each item positioned at the POS system and then the identification displayed by assisted checkout computing device 650 that will be apparent to those skilled in the relevant art(s) without departing from the spirit and scope of the invention.

Rather than have a cashier then proceed with scanning the items in which the customer requests to purchase and/or have the customer scan such items as positioned at the POS system, item identification computing device 610 may automatically identify the items in which the customer requests to purchase based on the images captured of the items by camera configuration 670. Assisted checkout computing device 650 may then automatically display the items in which the customer requests to purchase via user interface 660 based on the automatic identification of the items by item identification computing device 610. The customer may then verify that the displayed items are indeed the items that the customer requests to purchase and proceed with the purchase without intervention from the cashier.

As a result, the retailer may request that numerous items in which the retailer has for purchase in the numerous retail locations of the retailer be automatically identified by item identification computing device 610 as the customer presents any of the numerous items at the POS system to purchase. The retailer may have numerous items that differ significantly based on different item parameters. Each item includes a plurality of item parameters that when combined are indicative as to an identification of each corresponding item thereby enabling identification of each item by item identification computing device 610 based on the item parameters of each corresponding item. The item parameters associated with each item may be specific to the corresponding item in which each time the item is positioned at the POS system, the images captured of the corresponding item by camera configuration 670 depict similar item parameters thereby enabling item identification computing device 650 to identify the item each time the item is positioned at the POS system. The item parameters associated with each item may also be repetitive in which substantially similar items may continue to have the same item parameters such that the item parameters provide insight to item identification computing device 610 as to the item that has been selected for purchase by the customer. In doing so, the item parameters may be repetitively incorporated into substantially similar items such that the item parameters may continuously be associated with the substantially similar items thereby enabling the item to be identified based on the item parameters of the substantially similar items.

For example, a twelve ounce can of Coke includes item parameters specific to the twelve ounce can of Coke such as the shape of the twelve ounce can of Coke, the size of the twelve ounce can of Coke, the lettering on the twelve ounce can of Coke, the color of the twelve ounce can of Coke and so on. Such item parameters are specific to the twelve ounce can of Coke and differentiate the twelve ounce can of Coke from other twelve ounce cans of soda pop thereby enabling item identification computing device 610 to automatically identify the twelve ounce can of Coke based on such item parameters specific to the twelve ounce can of Coke. Additionally, each twelve once can of Coke as canned by Coca-Cola and distributed to the retail locations include substantially similar and/or the same item parameters as every other twelve ounce can of Coke canned by Coca-Cola and then distributed to the retail locations. In doing so, each time a twelve ounce can of Coke is positioned at any POS system at any retail location, item identification computing device 610 may automatically identify the twelve ounce can of Coke based on the repetitive item parameters specific to every twelve ounce can of Coke.

Item parameters may include but not limited to such as brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention.

In doing so, each item in which the retailer requests to be automatically identified by and displayed by assisted checkout computing device 610 may be presented to item identification computing device 610 such that item identification computing device 610 may be trained to identify each item in offline training. The training of item identification computing device 610 in offline training occurs when the item is provided to item identification computing device 610 for training offline from when the item is presented to assisted checkout computing device 650 such that offline training occurs independent from actual purchase of the item as presented to assisted checkout computing device 650. Each item may be presented to item identification computing device 610 such that item identification computing device 610 may scan each item to incorporate the item parameters of each item as well as associate the item parameters with a UPC and/or SKU associated with the item. Item identification computing device 610 may then associate the item parameters of the item to the UPC and/or SKU of the item and store such item parameters that are specific to the item and correlate to the UPC and/or SKU of the item in the item parameter identification database 620. For purpose of simplicity, UPC may be used throughout the remaining specification but such reference may include but is not limited to UPCs, IANs, EANs, SKUs, and/or any other scan related identification protocol that will be apparent from those skilled in the relevant art(s) without departing from the spirit and scope of the present disclosure.

Each iteration that the item is scanned by item identification computing device 610, such item parameters of the item of each scan may further be stored in item parameter identification database 620. The item parameters captured for each iteration of scanning the item may then be provided to item identification server 630 and incorporated into neural network 640 such that neural network 640 may continue to learn as to the item parameters associated with the item for each iteration thereby increasing the accuracy of item identification computing device 610 correctly identifying the item. In doing so, assisted checkout computing device 650 also increases the accuracy in displaying to the customer via user interface 660 the correct identification of the item in which the customer presents to the POS system to request to purchase thereby streamlining the purchase process for the customer and the retailer.

However, such training of item identification computing device 610 occurs in offline training in which the retailer presents a list of the items that the retailer requests to be automatically identified in which the list includes the item and corresponding UPC. Each item on the list is then provided to item identification computing device 610 and each item is continuously scanned by identification computing device 610 in order for a sufficient quantity of iterations to be achieved until item identification computing device 610 may accurately identify the item. Such offline iterations is time consuming and costly as assisted checkout computing device 650 may fail in accurately displaying the identification of the item to the customer via user interface 660 in which the customer requests to purchase until item identification computing device 610 has obtained the sufficient of quantity of iterations to correctly identify the item via neural network 640.

Further, the retailer may continuously be adding new items to the numerous retail locations of the retailer in which such new items are available to purchase by the customer. Item identification computing device 610 may have not had the opportunity to be trained on the continuously added new items in offline training. Often times, the retailer has numerous retail locations and the retailer may not have control over their own supply chain. In doing so, the retailer may not know when items will be arriving each of the numerous retail locations as well as when the items will be ultimately purchased and discontinued at each of the numerous retail locations. As a result, item identification computing device 610 may not have the opportunity to execute offline learning of such numerous items at each of the numerous retail locations. In doing so, the new items may be continuously presented for purchase to assisted checkout computing device 650 but assisted checkout computing device 650 may fail to correctly display identification of the item to the customer via user interface 660 due to item identification computing device 610 not having the opportunity to receive the quantity of iterations in offline training to identify the new items.

However, each time that the customer presents an item to assisted checkout computing device 650 in which item identification computing device 610 may not have had sufficient iterations to train in offline manner to identify the item may actually be an iteration opportunity for item identification computing device 610 to train in identifying the item in online training. Item identification computing device 610 may train in identifying the item in online training when the customer presents the item to assisted checkout computing device 650 for purchase such that camera configuration 670 captures images of the item parameters associated with the item thereby enabling item identification computing device 610 to capture an iteration of training at the POS system of the item rather than doing so offline.

The retailer may experience numerous transactions in which the customer requests to purchase the item in which item identification computing device 610 has not had the opportunity to sufficiently train in offline training. Such numerous transactions provide the opportunity for item identification computing device 610 to train in online training to further streamline the training process in identifying the items. Further, the training of item identification computing device 610 with iterations provided by the customer requesting to purchase the item at the POS system further bolsters the accuracy in the identification of the item by item identification computing device 610 even after item identification computing device has been sufficiently trained with iterations in offline training. Thus, the time in which to train item identification computing device 610 to accurately identify the item is decreased as well as the overhead to do so by adding the online training to supplement the offline training of item identification computing device 610.

As a result, the automatic identification of the items positioned at assisted checkout computing device 650 at the POS by item identification computing device 610 may enable the retailer to have the staff working at each retail location to execute tasks that have more value than simply scanning items. For example, the staff working at each retail location may then greet customers, stock shelves, perform office administration, and/or any other task that provides more value to the retailer as compared to simply scanning items. In doing so, the retailer may reduce the quantity of staff working at each retail location during each shift while also gaining move value from such staff working at each retail location during each shift due to the increase in value of the tasks that each staff member may now execute without having to scan items and/or manage a conventional self-checkout system that fails to automatically identify the items positioned at such conventional POS systems. The automatic identification of the items positioned at assisted checkout computing device 650 at the POS may also enable the retailer to execute a fully autonomous self-checkout system in addition to also reducing staff. Regardless, the automatic identification of the items positioned at assisted checkout computing device 650 at the POS provides the retailer with increased flexibility in staffing each retail location during each shift.

Item identification computing device 610 may be a device that is identifying items provided to assisted checkout computing device 650 for purchase based on images captured by camera configuration 670. One or more assisted checkout computing devices 650 may engage item identification computing device 610 in order to interface with of each of the customers and/or cashiers in real-time via user interface 660 with regard to their request for purchase of the item. User interface 660 may include any type of display device including but not limited to a touch screen display, a liquid crystal display (LCD) screen, a light emitting diode (LED) display and/or any other type of display device that includes a display that will be apparent from those skilled in the relevant art(s) without departing from the spirit and scope of the present disclosure.

### Correct Item Identification at the POS

Universal Product Codes (UPCs), International Article Numbers (IAN) and European Article Numbers (EAN) are conventionally used to identify items at the Points of Sale (POS) and other locations in retail, inventory management, supply chain, shipping and various other applications. Conventional, one-dimensional (1D) laser scanners have conventionally been used to read such codes. More recently, conventional two-dimensional (2D) image sensors (CCD and/or CMOS) have been conventionally used to detect UPCs. Such conventional detection models of UPCs typically includes a person pointing a scanner at a UPC or pointing the item UPC to the scanner to read the code. There are other conventional systems that read a UPC in the ambient without the need for a human to align the scanner and the UPC. There are also more recent conventional systems that read multiple UPCs simultaneously. In the conventional approaches, the UPC must be mostly visible and clear to the scanner.

Such conventional approaches to UPC scanning make UPC scanning challenging in situations where there are multiple items that might be occluding each other such that UPCs on each item may be blocked by the other items as well as instances in which the UPC is partially damaged or invisible due to frost on the product and so on. Conventional scanners operate in a unidirectional manner in which the scanner reads a barcode of a UPC and communicates it to the downstream system, such as the POS. However, if the barcode is not fully visible, or is damaged in some way, the scan fails. Further, if the scan does not pass a conventional error check, and cannot be corrected, the scan fails.

As discussed above, item identification computing device 610 may increase iterations in training of identification of items by incorporating online training triggered by the customer providing the item to assisted checkout computing device 650 for purchase in addition to incorporating the numerous iterations of offline training. At the outset, a master list of items with a corresponding UPC may be provided to assisted checkout computing device 650 such that assisted checkout computing device 650 may scan each item to determine the item parameters of each item and correspond such item parameters to the corresponding UPC and stored in item parameter identification database 620 during the offline training. As a result, the item parameters of each item may be mapped to the corresponding UPC stored in item parameter identification database 620. For example, item identification computing device 610 may identify 1000 to 2000 different items that are located in the numerous retail stores of the retailer based on the offline training triggered from the master list of items provided by the retailer.

However, as discussed above, the retailer may continuously incorporate numerous new items in which item identification computing device 610 has not had the opportunity to implement offline training on such new items via an updated master list provided by the retailer with the new items and corresponding UPCs. Rather than wait for offline training in order for item identification computing device 610 to execute sufficient iterations to identify the new items, item identification computing device 610 may be exposed to iterations of training on the new items via online training when the new items are presented to assisted checkout computing device 650 for purchase. Initially during online training, the customer may provide the item to assisted checkout computing device 650 in which the item is not currently mapped in item parameter identification database 620 such that item identification computing device 610 may not initially identify the item.

In doing so, item identification computing device 610 may instruct assisted checkout computing device 650 that item identification computing device 610 is unable to identify the item thereby triggering assisted checkout computing device 650 to display to the customer and/or cashier via user interface 660 that the item that the customer requests to purchase is not identified by item identification computing device 610. Assisted checkout computing device 650 may then trigger user interface 660 to notify the cashier that the item is not currently recognized by item identification computing device 610 and thereby instruct the cashier to scan the UPC of the item not currently recognized by item identification computing device 610. The unknown item and the corresponding UPC may then be immediately mapped to item parameter identification database 620 thereby indicating that the unknown item is associated with the scanned UPC.

Further, the item parameters of the unknown item as captured by camera configuration 670 may also be mapped to item identification database 620 thereby also indicating the item parameters in addition to the scanned UPC that is associated with the scanned UPC. As a result, immediate feedback as to the scanned UPC and the item parameters associated with the unknown item are mapped to item identification database 620. Each time the previously unknown item is presented to assisted checkout computing device 650 for purchase, item identification computing device 610 may then query item parameter identification database 620 for a match in the UPC and item parameters to identify the previously unknown item. Thus, item identification computing device 610 may execute iterations of online training based on the UPC and item parameters associated with the previously unknown item immediately mapped to item parameter identification database 620.

After the previously unknown item is mapped to item parameter identification database 620 with the corresponding UPC and item parameters, item identification computing device 610 may then begin to recognize the item despite the UPC associated with the item unavailable and/or unrecognizable as captured by image configuration 670. Each time the item is presented to assisted checkout computing device 650 by the customer for purchase and camera configuration 670 is unable to adequately capture the UPC associated with the item, item identification computing device 610 may then attempt to match the item parameters associated with the item as captured by camera configuration 670 to item parameters previously stored in item parameter identification database 620. Item identification computing device 610 may then determine the UPC that is associated with item parameters previously stored in item parameter identification database 620 that match the item parameters of the current item that the customer requests to purchase in which the UPC is currently unable to be captured by camera configuration 670. Item identification computing device 610 may then instruct assisted checkout computing device 650 to display to the customer via user interface 660 the correct identification of the item despite camera configuration 670 being unable to identify the UPC of the item.

Item identification computing device 610 may extract a plurality of Universal Product Code (UPC) features included in a plurality of item parameters associated with each item positioned on the POS system from the plurality of images captured of each item by the camera configuration 670. The UPC features associated with each item when combined are indicative as to an identification of the UPC of each item. As discussed above, item parameters may include but not limited to brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention. Item parameters also include UPC features in which the UPC features are item parameters specific to the UPC of the item. Further as discussed above, for purpose of simplicity, UPC may be used throughout the remaining specification but reference of UPC features may also include item parameters specific to and may include but is not limited to UPCs, IANs, EANs, SKUs, and/or any other scan related identification protocol that will be apparent from those skilled in the relevant art(s) without departing from the spirit and scope of the present disclosure in which the.

Often times camera configuration 670 is unable to capture the UPC and/or may simply capture a partial view of the UPC in which case item identification computing device 610 may be in a position to identify the item without being able to match the UPC of the item to UPCs previously mapped to item parameter identification database 620. As discussed above, item parameter identification database 620 may receive a master list of UPCs in the inventory of a retailer that may define the domain from which UPCs may be generated. Item identification computing device 610 may then produce the best match among the master list to the UPC that may be unavailable, partially identified, and/or identified with errors.

For example, camera configuration 670 unable to capture the UPC of an item but rather captures a partial view of the UPC in which camera configuration 670 captures the UPC features of the partial digits of the UPC and the partial barcode of the UPC. Each UPC includes a plurality of characters that is indicative as to the identification of the item such as digits, numerals, letters, symbols, and/or any other characters and/or combination of characters that will be apparent to those skilled in the relevant art(s) without departing from the spirit and scope of the invention. Each UPC also includes a barcode that is indicative as to the identification of the item. In such an example, camera configuration 670 captures the UPC feature of the partial digits of the UPC which is a portion of the digits of the UPC and not the complete string of digits of the UPC as well as the UPC feature of the partial barcode which is a portion of the barcode of the UPC and not the complete barcode of the UPC.

Item identification computing device 610 may analyze the UPC features with each item positioned at the POS system to determine whether the UPC features associated with each item when combined matches a corresponding combination of the UPC features stored in item parameter identification database 620. Item parameter identification database 620 stores different combinations of UPC features with each different combination of UPC features associated with a corresponding item thereby identifying each corresponding item based on each different combination of UPC features associated with each item. Item identification computing device 610 may identify each corresponding item positioned at the POS system when the UPC features associated with each item when combined match a corresponding combination of UPC features as stored in item parameter identification database 620 and fail to identify each corresponding item when the UPC features associated with each item when combined fail to match a corresponding combination of UPC features.

For example, item identification computing device 610 may analyze the UPC features of the partial digits of four digits of “4007” of the UPC as well as the UPC features of a partial barcode of the UPC as extracted from the images captured by camera configuration 670. Item identification computing device 610 may then combine the partial digits of the four digits of “4007” of the UPC as well as the UPC features of the partial barcode and determine whether the partial digits of the four digits “4007” of the UPC when combined with the UPC features of the partial barcode matches any partial digits of the four digits “4007”′ of the UPC and UPC features of the partial barcode as stored in item parameter identification database 620. Item identification computing device 610 may then determine that the match of the partial digits of four digits of “4007” of the UPC and the UPC features of the partial barcode matches the partial digits of four digits of “4007” of the UPC and the UPC features of the partial barcode of the item of a 12 ounce can of Coke as stored in item parameter identification database 620. Item identification computing device 610 may then identify the item with the partial digits of four digits of “4007” of the UPC and the UPC features of the partial barcode as being the item of the 12 ounce can of Coke despite only extracting the partial digits and the partial barcode of the UPC of the item presented to the POS for purchase.

Item identification computing device 610 may create a hash of the master list of UPCs to store in item parameter identification database 620 in order for item identification computing device 610 to create a hash map. In doing so, item identification computing device 610 may increase the rate in which item identification computing device 610 searches item parameter identification database 620 for partial matching of a UPC that is only partially captured by camera configuration 670. As a result, item identification computing device 610 may create a searchable database in item parameter identification database 620 of item parameters such as features of the item as captured by images of the item by camera configuration 670 that are associated with the item and thereby mapped into item parameter identification database 620.

Camera configuration 670 may capture a UPC associated with an item in a scene of items that may be positioned at assisted checkout computing device 650 for purchase by the customer. Camera configuration 670 may capture as much of the UPC as is visible to camera configuration 670 and item identification computing device 610 may decode the UPC and/or whatever part of the UPC that may have been captured of the UPC and may do simultaneously as camera configuration 670 is capturing the images of the UPC and/or partial UPC. Camera configuration 670 may also capture the text of UPC through Optical Character Recognition (OCR).

Item identification computing device 610 may then do a fuzzy matching against the master list of inventories of UPCs as stored in item parameter identification database 620. Item identification computing device 610 may then determine the closest match of the UPCs stored in item parameter identification database 620 to the partially identified UPC based on the fuzzy matching. Item identification computing device 610 may then present the item with the UPC that is the closest match to the partially identified UPC to assisted checkout computing device 650 to display the identified item to the customer and/or cashier via user interface 660. In doing so, item identification computing device 610 may search for the UPC in the master list that best matches the digits of the partially captured UPC even if the digits of the partially captured UPC pertain to different sections of UPC that is the best match as stored in item identification computing device 610.

Item identification computing device 610 may extract the plurality of item parameters associated with each item positioned at the POS system from the plurality of images captured of each item by camera configuration 670 positioned at the POS system. The item parameters associated with each item when combined with the extracted UPC features associated with each item are indicative as to the identification of each corresponding item thereby enabling the identification of each corresponding item. As discussed above, the item parameters may include the UPC features of the UPC associated with the item but also numerous other item parameters associated with the item such as but not limited to brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention.

Item identification computing device 610 may analyze the item parameters associated with each item positioned at the POS system in combination with the UPC features associated with each item positioned at the POS system to determine whether the item parameters when combined with the combination of UPC features matches a corresponding combination of the item parameters stored in item parameter identification database 620. Item parameter identification database 620 stores different combinations of item parameters with different combinations of UPC features with each different combination of item parameters when combined with each different combination of UPC features are associated with a corresponding item thereby identifying each corresponding item based on each different combination of item parameters when combined with each different combination of UPC features. Item identification computing device 610 may identify each corresponding item positioned at the POS system when the item parameters associated with each item when combined with the UPC features associated with each item match a corresponding combination of item parameters and UPC features as stored in item parameter identification database 620.

For example, item identification computing device 610 may automatically identify the twelve ounce can of Coke when the combination of item parameters extracted from the images captured of the twelve ounce can of Coke match the combination of item parameters stored in item parameter identification database 620 that are associated with the twelve ounce can of Coke. In such an example, item identification computing device 610 may further automatically identify the twelve ounce can of Coke when the combination of item parameters and the UPC features extracted from the images captured of the twelve once can of Coke match the combination of item parameters and UPC features stored in item parameter identification database 620 that are associated with the twelve ounce can of Coke. Thus, item identification computing device 610 thereby automatically identifies the twelve ounce can of Coke positioned at the POS system and assisted checkout computing device 650 displays the identification of the twelve ounce can of Coke to the customer despite item identification computing device 610 despite only extracting the partial digits and the partial barcode of the UPC of the item presented to the POS for purchase.

Item identification computing device 610 may fuse together different item parameters associated with the item in which the UPC is partially captured by camera configuration 670 and/or unable to be captured by camera configuration 670. As discussed above, the item may have item parameters associated with the item in which such item parameters that when identified by item identification computing device 610 may provide an indication as to the identification of the item. As the customer presents the item to assisted checkout computing device 650, camera configuration 670 may capture different item parameters of the item that may be indicators of the identification despite camera configuration 670 partially capturing the UPC and/or unable to capture the UPC of the item.

Item identification computing device 610 may then fuse together the different item parameters captured by camera configuration 670 in which the fusing together of the different item parameters may further bolster the identification of the item by item identification computing device 610 despite only having a partial identification of the UPC and/or no identification of the UPC. The item parameters associated with the item as captured by camera configuration 670 may be multi-modal information in which the item parameters may be classified into different modes of information. For example, the item parameters associated with the item may be classified into visible features, text features, and metrology features. The item parameters of the item as classified into visible features, text features, and metrology features may then be uploaded into item identification computing device 610 in a multi-modal approach. Item identification computing device 610 may then fuse together the multi-modal information from the visible features, the text features, and the metrology features of the item parameters associated with the item to identify the item based on such fusion of features. The item parameters associated with the item may be partitioned into any type of multi-modal information that when fused together with other type of multi-modal information may identify the item that will be apparent to those skilled in the relevant art(s) without departing from the spirit and scope of the invention.

For example, the twelve ounce can of Coke may be positioned at the POS system by the customer for purchase and item identification computing device 610 may automatically identify the twelve ounce can of Coke based on the combination of item parameters and UPC features associated with the twelve ounce can of Coke as discussed above. However, a twelve ounce can of holiday Coke may be positioned at the POS system. The retailer may have not had the opportunity to conduct offline training of item identification computing device 610 with regard to automatically identifying the twelve ounce can of holiday Coke as the retailer may have had no notification as to when the twelve ounce cans of holiday Cokes were scheduled to arrive at the retail location and be stocked on the shelves of the retail location. The twelve ounce can of holiday Coke differs in color and design from the standard twelve ounce can of holiday Coke. Thus, in such an example, item identification computing device 610 automatically extracts the item parameters and the UPC features associated with the twelve ounce can of holiday Coke from the images captured of the twelve ounce can of holiday Coke identifies the twelve ounce can of holiday Coke by matching the item parameters and the UPC features associated with the twelve ounce can of holiday Coke as stored in item parameter identification database 620.

Item identification computing device 610 may extract a plurality of text features from the plurality of images captured of each item by camera configuration 1970 positioned at the POS system that includes a plurality of digits and a barcode of each UPC of each item positioned at the POS system. The digits of each UPC and the barcode of each UPC captured from the plurality of images of each item is partial digits of each UPC and the barcode of each UPC captured from the plurality of images of each item is a partial barcode of each UPC.

Item identification computing device 610 may compare the partial digits of each UPC and the partial barcode of each UPC as captured from the images of each item to a complete set of digits and a complete barcode of each UPC associated with each item stored in item parameter identification database 620. Item parameter identification database 620 stores the complete set of digits and the complete barcode of each UPC associated with each item. For example, item parameter identification database 620 stores the complete set of digits for the twelve ounce can of Coke and the complete barcode of the twelve ounce can of Coke for the UPC for the twelve ounce can of Coke thereby providing the identification of the twelve ounce can of Coke based on the complete UPC for the twelve ounce can of Coke.

Item identification computing device 610 may determine whether the partial digits of each UPC and the partial barcode of each UPC as captured from the images of each item when combined matches a corresponding combination of digits and barcode included in the complete set of digits and the complete barcode of each UPC as stored in item parameter identification database 620. Item identification computing device 610 may identify each corresponding item positioned at the POS system when the partial digits of each UPC and the partial barcode of each UPC when combined match a corresponding combination of digits and barcode included in the complete set of digits and the complete barcode of each UPC as stored in item parameter identification database 620.

As provided in the example above, item identification computing device 610 may analyze the UPC features of the partial digits of four digits of “4007” of the UPC as well as the UPC features of a partial barcode of the UPC as extracted from the images captured by camera configuration 670. Item identification computing device 610 may then combine the partial digits of the four digits of “4007” of the UPC as well as the UPC features of the partial barcode and determine whether the partial digits of the four digits “4007”′ of the UPC when combined with the UPC features of the partial barcode matches any partial digits of the four digits “4007” of the UPC and UPC features of the partial barcode as stored in item parameter identification database 620. Item identification computing device 610 may then determine that the match of the partial digits of four digits of “4007” of the UPC and the UPC features of the partial barcode matches the partial digits of four digits of “4007” of the UPC and the UPC features of the partial barcode of the item of a 12 ounce can of Coke as stored in item parameter identification database 620. Item identification computing device 610 may then identify the item with the partial digits of four digits of “4007” of the UPC and the UPC features of the partial barcode as being the item of the 12 ounce can of Coke despite only extracting the partial digits and the partial barcode of the UPC of the item presented to the POS for purchase.

In doing so, item identification computing device 610 may fuse together the different item parameters captured by camera configuration 670 and then query item parameter identification database 620 for the best match of the fused together item parameters as stored in item parameter identification database 620. As discussed above, each item stored in item parameter identification database 620 is associated with a UPC that identifies the item as well as item parameters that are associated with the item and are indicative as to the identifying the item. As the item parameters that are fused together increase, the likelihood of identifying a correct match of such fused together features associated with an item as identified and stored in item parameter identification database 620. For example, visible features, text features, and metrology features as captured by camera configuration 670 from the unknown item and fused together may match with visible features, text features, and metrology features of an item stored in item parameter identification database 620 thereby enabling identification computing device 610 to correctly identify the unknown item.

Rather than simply attempting to identify the unknown item by querying item parameter identification database 620 for the best match of UPCs associated with items stored in item parameter identification database 620, item identification computing device 610 may fuse together with the text features of the partial UPC of the unknown item, the visible features as well as the metrology features of the unknown item. In doing so, the likelihood of correctly identifying the best match of the unknown item based on the text features of the partial UPC, visible features, and metrology features to similar features of the partial UPC, visible features, and metrology features associated with an item stored in item parameter identification database 620 increases due to the fused together features to match as compared to simply attempting to match the partial UPC.

For example, each time that the twelve ounce can of holiday Coke is positioned at the POS system, item identification computing device 610 may extract the item parameters of the twelve ounce can of holiday Coke including the color and design as well as the UPC features of the twelve ounce can of holiday Coke including the partial digits and partial barcode. Item identification computing device 610 may then combine the item parameters of the color and design of the twelve ounce can of holiday Coke with the UPC features of the twelve ounce can of holiday Coke of the partial digits and partial barcode and match the item parameters of the color and design and the partial digits and partial barcode with such item parameters and UPC features stored in item parameter identification database 620. Item identification computing device 610 may then identify the item as the twelve ounce can of holiday Coke despite only extracting the partial digits and the partial barcode of the UPC of the item presented to the POS for purchase.

Item identification computing device 610 may determine a location of the partial digits of each UPC as captured from the images of each item as positioned relative to the complete set of digits of each UPC and a location of the partial barcode of each UPC as captured from the images of each item as positioned relative to the complete barcode of each UPC. Item identification computing device 610 may determine whether the location of the partial digits of each UPC and the location of the partial barcode of each UPC when combined matches a corresponding location of digits and barcode included in the complete set of digits and the complete barcode of each UPC as stored in the item parameter identification database 620. Item identification computing device 610 may identify each corresponding item positioned at the POS system when the location of the partial digits of each UPC and the location of the partial barcode of each UPC when combined match a corresponding location of digits and location of barcode included in the complete set of digits and complete barcode of each UPC as stored in item parameter identification database 620.

For example, item identification computing device 610 may determine that the location of the partial digits of the UPC of the item of “4007” is the location of the first four digits of the UPC of the item as extracted from the images captured of the item by camera configuration 670. Item identification computing device 610 may also determine that the location of the partial barcode of the UPC of the item is positioned in the center sequence of the barcode of the item as extracted from the images captured of the item by camera configuration 670. Item identification computing device 610 may then combine the location of the partial digits of “4007” as the location of the first four digits of the UPC and the location of the partial barcode of the UPC as the center sequence to determine whether the partial digits of “4007” as location of the first four digits of the UPC and the location of the partial barcode of the UPC as the center sequence matches such a combination as stored in item parameter identification database 620. Item identification computing device 610 may determine that the partial digits of “4007” as location of the first four digits of the UPC and the location of the partial barcode of the UPC as the center sequence matches such a combination of the twelve ounce can of holiday Coke as stored in item parameter identification database 620. Item identification computing device 610 may then identify the item as the twelve ounce can of holiday Coke despite only extracting the partial digits and the partial barcode of the UPC of the item presented to the POS for purchase.

Item identification computing device 610 may receive a plurality of images captured of the UPC features of each item positioned on the POS system by camera configuration 670 positioned at the UPC system. Each different image captured by each different camera captures a different set of UPC features of each item positioned at the UPC system. Item identification computing device 610 may extract each different set of UPC features from each different image captured by each different camera. Each different set of UPC features captured by each different camera is a different image clip of UPC features depicting different partial UPC features of each corresponding UPC associated with each item positioned on the POS system.

For example, item identification computing device 610 may receive images of the UPC features of the item in which a first image captures the partial UPC feature of partial digits of “4007” and the partial UPC feature of the center sequence of the partial barcode and a second image captures the partial UPC feature of partial digits “2355” and the partial UPC feature of the left sequence of the partial barcode. In doing so, each image captured by each camera captures a different set of UPC features of the item positioned at the UPC system in the partial digits of “4007” and “2355” and the center sequence and the left sequence of the partial barcode. The partial digits of “4007” and the center sequence of the partial barcode of the first image is a first image clip of the UPC features of the item and partial digits “2355” and the left sequence of the partial barcode of the second image is a second image clip of the UPC features as extracted by item identification computing device 610. In doing so, the first image clip depicts different partial UPC features of the partial digits of “4007” and the center sequence of the partial barcode as compared to the second image clip depicts different partial UPC features of the partial digits of “2355” and the left sequence of the partial barcode.

Item identification computing device 610 may fuse together each different set of UPC features from each different image clip of UPC features depicting different partial features of each UPC associated with each item as extracted from each different image captured by each different camera of the UPC features of each item positioned on the POS system. Each different set of UPC features from each different image clip of UPC features depicting different partial features of each UPC when fused together depict an increased set of UPC features of each UPC associated with each item.

For example, item identification computing device 610 may fuse together the partial digits of “4007” as depicted in the first image clip with the partial digits of “2355” depicted in the second image clip to depict an increased partial UPC feature of the partial digits to be “4007” and “2355” thereby increasing the quantity of partial digits identified from the partial UPC. Further, item identification computing device 610 may fuse together that partial barcodes of the center sequence depicted in the first image clip and the left sequence depicted in the second image clip to depict an increased partial UPC feature of the center sequence and the left sequence thereby increasing the barcode identified from the partial UPC. Further, item identification computing device 610 may fuse together the partial digits of “4007” and “2355” with the partial barcodes of the center sequence and the left sequence to depict an increased partial UPC features of the combined partial digits of the first image clip and the second image clip with the combined partial barcodes of the first image clip and the second image clip.

Item identification computing device 610 may compare each fused set of UPC features from each different image clip of UPC features of each UPC to a complete set of UPC features of each UPC associated with each item stored in item parameter identification database 620. Item parameter identification database 620 stores the complete set of UPC features of each UPC associated with each item. Item identification computing device 610 may determine whether each fused set of UPC features from each different image clip of UPC features of each UPC when combined matches a corresponding set of UPC features in the complete set of UPC features of each UPC as stored in item parameter identification database 620. Item identification computing device may identify each corresponding item positioned at the POS system when each fused set of UPC features from each different image clip of UPC features of each UPC when combined match a corresponding set of UPC features in the complete set of UPC features of each UPC as stored in item parameter identification database 620.

For example, item identification computing device 610 may compare the fused together partial digits of “4007” and “2355” with the partial barcodes of the center sequence and the left sequence of the first image clip and the second image clip to the complete set of UPC features stored in item parameter identification database 620. In such an example, item parameter identification database 620 includes a complete of UPC features that includes the partial digits of “4007” and “2355” with the partial barcodes of the center sequence and the left sequence that identifies the twelve ounce can of holiday Coke. As a result, item identification computing device 610 identifies the item with the partial digits of “4007” and “2355” and the partial barcodes of the center sequence and the left sequence as fused together rom the first image clip and second image clip to be the twelve ounce can of holiday Coke despite only extracting the partial digits and the partial barcode of the UPC of the item presented to the POS for purchase.

Camera configuration 670 may have multiple cameras in which each camera may capture a different image clip of the UPC. In doing so, item identification computing device 610 may fuse together each of the different image clips of the partially captured UPC such that item computing device 610 may fuse together the text features of the UPC from each image clip captured by each camera. The fusing together of the text features of the UPC from each image clip captured by each camera may create a more complete text of the UPC which may then be implemented in querying item parameter identification database 620 for the best match fused together text features of the UPC to the UPCs associated with each item as stored in item parameter identification database 620. In doing so, the likelihood of item identification computing device 610 in correctly identifying the unknown item based on the fused together text features of the UPC from each image clip increases as compared to simply attempting to match a single image that partially captures the UPC as the fused together text features of the UPC from each image clip may provide a more complete representation of the UPC of the unknown item as compared to a capture of the UPC from a single image clip.

Item identification computing device 610 may infer the location of a partial capture of the partially captured UPC of the unknown item from the entire UPC as if the entire UPC is captured by camera configuration 670. In doing so, item identification computing device 610 may attempt to identify the location of the partial capture of the partially captured UPC by camera configuration 670 is located relative to the entire UPC as if the entire UPC is captured by camera configuration 670. Item identification computing device 610 may then query item parameter identification database 620 for the best match as to the location of the partially captured UPC in which item identification computing device 610 may search for entire UPCs associated with items stored in item parameter identification database 620 that include the partially captured UPC in a similar location in the entire UPC.

As discussed above, camera configuration 670 may have multiple cameras in which each camera may capture a different image clip of the unknown item. In doing so, each image clip of the unknown item may capture item parameters associated with the unknown item. Item identification computing device 610 may fuse then together each of the different image clips of the unknown item to have a more fully identification of the unknown item based on the item parameters captured of the unknown from each of the different image clips. Each of the different image clips as captured by each of the cameras included in camera configuration 670 may be stored in item parameter identification database 620. In doing so, item identification computing device 610 may query item parameter identification database 620 for image clips that include item parameters of items stored in item identification computing device 610 that match the image clips that include item parameters of the unknown item as captured by each of the cameras of camera configuration 670 to identify the unknown item based on the image parameters that are captured by the image clips stored in item parameter identification database 620 that best match the item parameters captured by the image clips captured by the cameras of camera configuration 670.

For example, each image clip of the unknown item may capture visual features associated with the unknown item. Item identification computing device 610 may then fuse together each of the different image clips of the unknown item to have a more fully identification of the unknown item based on the visual features captured of the unknown item from each of the different image clips. Each of the different image clips as captured by each of the cameras included in camera configuration 670 may be stored in item parameter identification database 620. In doing so, item identification computing device 610 may query item parameter identification database 620 for image clips that include visual features of items stored in item identification computing device 610 that match the image clips that include visual features of the unknown item as captured by each of the cameras of camera configuration 670 to identify the unknown item based on the visual features that are captured by the image clips stored in item parameter identification database 620 that best match the visual features captured by the image clips captured by the cameras of camera configuration 670.

In such an example, the visual features of the color and design of the unknown item as captured by each image clip may be fused together that the unknown item may be correctly identified based on the visual features of the color and design of the unknown item. The unknown item may be a twelve ounce can of Coke including the color and design of the unknown item. However, the color and design of the unknown item as captured by each image clip may be fused together such that the unknown item may be correctly identified. The color and design of the unknown item that may be a twelve ounce can of Coke may instead be the color and design of a twelve ounce can of holiday Coke. In doing so, the color and design of the twelve ounce can of holiday Coke may be correctly identified by item identification computing device 610 by querying item parameter identification database 620 for visual features that match the fused together image clips of the unknown item which is the twelve ounce can of holiday Coke. As a result, item identification computing device 610 may correctly identify the unknown item as the twelve ounce can of holiday Coke as compared to the standard twelve ounce can of Coke based on the visual features of the color and design as captured by the fused together image clips.

In another example, each image clip of the unknown item may capture text features associated with the unknown item. In such an example, such text features may include but are not limited to the brand of the unknown item as presented by the text on the unknown item, ingredients of the unknown item as presented by the text on the unknown item, the weight of the unknown item as presented by the text of the unknown item. The text features of the unknown item may be any type of text that is associated with the unknown item and captured by camera configuration that are item parameters in which such text provides an indication as to the identity of the unknown item that will be apparent to those skilled in the relevant art(s) without departing from the spirit and scope of the invention.

Item identification computing device 610 may fuse then together each of the different image clips of the unknown item to have a more fully identification of the unknown item based on the text features captured of the unknown from each of the different image clips. Each of the different image clips as captured by each of the cameras included in camera configuration 670 may be stored in item parameter identification database 620. In doing so, item identification computing device 610 may query item parameter identification database 620 for image clips that include text features of items stored in item identification computing device 610 that match the image clips that include text features of the unknown item as captured by each of the cameras of camera configuration 670 to identify the unknown item based on the text features that are captured by the image clips stored in item parameter identification database 620 that best match the text features captured by the image clips captured by the cameras of camera configuration 670.

In another example, each image clip of the unknown item may capture metrology features associated with the unknown item. In such an example, such metrology features may include but are not limited to the height, the width, and the length of the unknown item. The metrology features of the unknown item may be any type of metrology feature that is associated with the unknown item and captured by camera configuration that are item parameters in which such metrology feature provides an indication as to the identity of the unknown item that will be apparent to those skilled in the relevant art(s) without departing from the spirit and scope of the invention.

Item identification computing device 610 may then fuse together each of the different image clips of the unknown item to have a more fully identification of the unknown item based on the metrology features captured of the unknown from each of the different image clips. Each of the different image clips as captured by each of the cameras included in camera configuration 670 may be stored in item parameter identification database 620. In doing so, item identification computing device 610 may query item parameter identification database 620 for image clips that include metrology features of items stored in item identification computing device 610 that match the image clips that include metrology features of the unknown item as captured by each of the cameras of camera configuration 670 to identify the unknown item based on the metrology features that are captured by the image clips stored in item parameter identification database 620 that best match the metrology features captured by the image clips captured by the cameras of camera configuration 670.

Item identification computing device 610 may conduct searches for the best match based on all of the image parameters captured by the different image clips from each of the cameras included in camera configuration 670 which may include any combination of image parameters included in the visual features, text features, and/or metrology features. In doing so, item identification computing device 610 may search for the best match for the combination of image parameters as captured by the different image clips from each of the cameras included in camera configuration 670 to the image parameters that are associated with items as stored in item parameter identification database 620 to identify the unknown item.

For example, such a search may first pair down the list of items stored in item parameter identification database 620 that may be a potential match to the unknown item by first implementing the UPC search. In doing so, item identification computing device 610 may first query item parameter identification database 620 for the items stored in item parameter identification database 620 that have potential matches to the partial UPC captured from the unknown item to generate a decreased list of items that may be a potential match. Item parameter identification computing device 610 may then incorporate the other item parameters associated with the unknown item as captured by camera configuration 670 to identify the best match of the item that is included on the decreased list of items that may match the unknown item based on the partial UPC captured from the unknown item.

The item identification computing device 610 may also first pair down the list of items stored in item parameter identification database 620 that may be a potential match to the unknown item by first fusing some of the image parameters to implement the search. For example, item identification computing device 610 may first fuse the text of the UPC from different image clips of the unknown item as captured by each of the different cameras of camera configuration 670 to create a more complete text of the UPC. In doing so, item identification computing device 610 may first query item parameter identification database 620 for the items stored in item parameter identification database 620 that have potential matches to the text of the UPC as fused together by the different image clips captured from the unknown item to generate a decreased list of items that may be a potential match. Item parameter identification computing device 610 may then incorporate the other item parameters associated with the unknown item as captured by camera configuration 670 to identify the best match of the item that is included on the decreased list of items that may match the unknown item based on the text of the UPC as fused together by the different image clips captured from the unknown item.

In an embodiment, the identification of the unknown item by item identification computing device 610 may be incorporated to create a confidence level in the match result to be used downstream in a self-checkout system that has further information such as item priors for each item, affinities with other items, the customer journey and so on.

Item identification computing device 610 may continuously stream item parameter data and UPC feature data such that item identification server 630 may accumulate item parameter data and UPC feature data as stored in item parameter identification database 620. In doing so, item identification server 630 may continuously accumulate item parameter data and UPC feature data as associated with the capturing of images of each item as streamed by item identification computing device 610 each time an item is positioned at a corresponding POS system. The item parameter data and the UPC feature data is accumulated from the pixels of each image and analyzed to recognize different item parameters and UPC features that are depicted by each image. Over time as the item identification data and the UPC feature data is accumulated by item identification server 630 continues to increase, neural network may then apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

Each time that item parameter data and UPC feature data is streamed to item identification server 630, neural network 640 may then assist item identification computing device 610 by providing item identification computing device 610 with the appropriate recognition of the item by item identification computing device 610 to correctly recognize the item depicted by the image. Neural network 640 may assist item identification computing device 610 in learning as to the appropriate item depicted by the image based on the item identification data and the UPC feature data such that neural network 640 may further improve the accuracy of item identification computing device 610 in automatically recognizing the appropriate item depicted by the image to further enhance the analysis of the image. Neural network 640 may provide item identification computing device 610 with improved accuracy in automatically recognizing the appropriate item depicted by the image such that neural network 640 may continue to learn upon with the accumulation of item identification data and UPC feature data that is provided by item identification computing device 610 and/or any computing device associated with item identification configuration 600 to item identification server 630. Thus, recognition of images depicted by images by item identification computing device 610 may further enhance the identification of previously unknown items as positioned at any POS system at any retail location.

### Structure and Dimensions of Example Assisted Checkout Devices

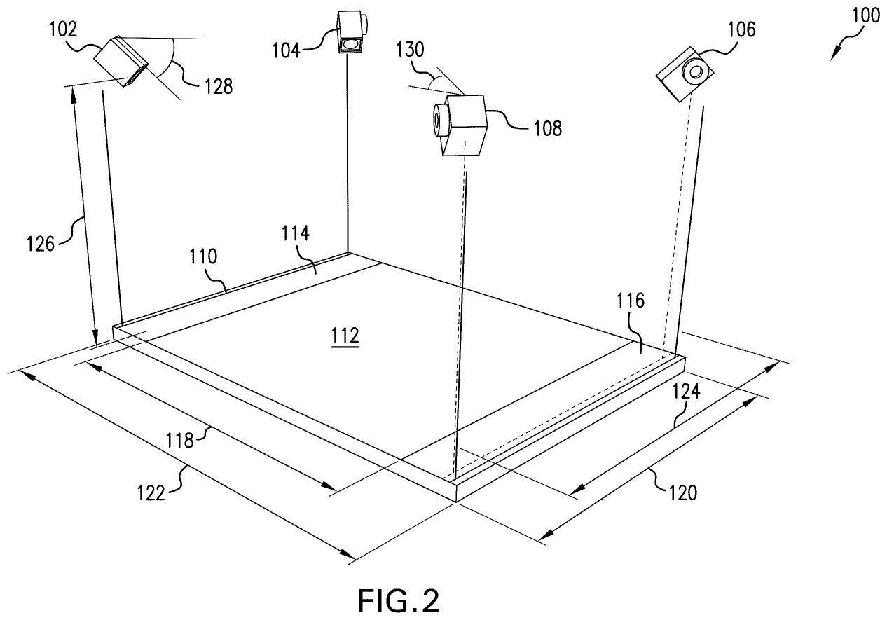

FIG. 2 shows an example device 100 for assisted checkout. A number of cameras 102, 104, 106, 108 are positioned above, and oriented downward and inward to observe from different angles, a checkout plane 112, which can, in some examples, be on the upper surface of a structural base 110 of the device 100. Although the illustrated example device 100 shows four cameras 102, 104, 106, 108 observing the checkout plane 112, other embodiments may have more or fewer cameras. For example, in some embodiments, a fifth camera (not shown in FIG. 2) may be placed directly above the checkout plane 112, e.g., directly above about the geometric center of the checkout plane, oriented to look directly down on the checkout plane 112, normal to the surface of the base 110. In other embodiments, the base 110 can be transparent and a fifth camera can be positioned below the checkout plane 112, oriented to look directly up at the checkout plane 112. Some examples of the device 100 may rigidly define the positions and/or orientations of the cameras 102, 104, 106, 108 relative to the checkout plane 112 via support posts for the cameras 102, 104, 106, 108 that are affixed to the base 110. Other examples of the assisted checkout device 100 may omit the base 110 and instead provide the cameras 102, 104, 106, 108 as suspended from overhead of the checkout plane 112. For example, the cameras 102, 104, 106, 108 can be rigidly affixed to a frame or ring that can be hung from a ceiling of a store.

In some examples, the checkout plane 112 may be defined by the base 110 of the assisted checkout device 100 via structural features indicative of a boundary, such as walls, lights, surface textures, surface materials, surface colors, surface elevations, or markings. This boundary may serve either as an indicator to a customer using the assisted checkout device 100 that only items placed wholly within the confines of the boundary should be expected to be properly observed by the cameras 102, 104, 106, 108 and added to a checkout list of items for purchase, or as self-enforcing structural feature requiring items for checkout to be placed within the confines of the boundary. In the illustrated example shown in FIG. 2, the boundary of the checkout plane 112 is defined by margins 114, 116, which can, for example, be of different color, texture, surface material, or elevation. The checkout plane 112 can be square, rectangular, circular, oval, or of any other two-dimensional shape. In the illustrated example, the checkout plane 112 is square/rectangular. In examples having a square or rectangular checkout plane 112, the checkout plane 112 has a first dimension 118 and a second dimension 120. In some examples, the first dimension 118 is between about 24 inches and about 36 inches, e.g., about 24 inches. In some examples, the second dimension 120 is between about 12 inches and about 30 inches, e.g., about 24 inches. In some examples, the second dimension 120 may be shorter than the first dimension 118. The illustrated example has a checkout plane 112 that is 2 feet by 2 feet. Other examples may have different dimensions, such as 2 feet by 3 feet.

In examples having a structural base 110, the base 110 of the assisted checkout device 100 can, for example, have dimensions equal or greater than the checkout plane 112. For example, the base 110 can be square or rectangular having a first dimension 122 and a second dimension 120. In the illustrated example, the second dimension of the base 110 is equal to the second dimension 120 of the checkout plane 112. In some examples, the first dimension 122 of the base 110 is between about 24 inches and about 44 inches, e.g., about 32 inches. In some examples, the second dimension 120 of the base 110 is between about 12 inches and about 30 inches, e.g., about 24 inches. In some examples, the second dimension 120 may be shorter than the first dimension 122. The illustrated example has a base 110 that is 24 inches by 32 inches. Other examples may have different base dimensions, such as 24 inches by 44 inches.

The cameras 102, 104, 106, 108 may be positioned with their focal points above the checkout plane 112 each by the same camera height or by a different camera height for each camera. In the illustrated example of FIG. 2, the focal points of all of the cameras 102, 104, 106, 108 are positioned above the base by the same camera height 126. For example, the focal points of the cameras 102, 104, 106, 108 may be positioned above the base at a camera height 126 of between about 10 inches and about 25 inches, e.g., between about 15 inches and about 20 inches. In the illustrated example, the cameras 102, 104, 106, 108 are positioned with their focal points above the base at a camera height of 18.1374 inches. In the illustrated example, the cameras 102, 104, 106, 108 are each positioned with their focal points offset from the geometric center of the checkout plane 112 by 15.5 inches in a first horizontal dimension and by 11.5 inches in a second horizontal dimension. In other examples, the respective horizontal positions of the cameras 102, 104, 106, 108 can vary and can depend on the size of the base 110 and/or the fields of view of the respective cameras 102, 104, 106, 108.

The cameras 102, 104, 106, 108 can be oriented to look down at the checkout plane 112 so as to have a variety of views of items placed on the checkout plane 112. In some examples, the cameras 102, 104, 106, 108 can each be oriented to have their respective optical axes point at about a same point in three-dimensional space (e.g., at a point above the geometric center of the plane 112), as in the illustrated example, or in other examples they can each be oriented to have their respective optical axes point at different respective points in three-dimensional space above the checkout plane 112. The cameras 102, 104, 106, 108 can each be oriented at a downward vertical angle (a downward tilt angle) 128 that can be dependent on their respective camera heights above the checkout plane 112. As an example, the cameras 102, 104, 106, 108 can each be oriented at a downward tilt angle 128 of between about 40° and about 50°, e.g., about 44°, from level horizontal. The cameras 102, 104, 106, 108 can each be oriented at an inward horizontal angle (an inward pan angle) 130 that can be dependent on their respective horizontal-dimension positions with respect to the geometric center of the checkout plane 112. As an example, the cameras 102, 104, 106, 108 can each be oriented at an inward pan angle 130 of between about 30° and about 50°, e.g., between about 39° and about 40°, as measured from an outer dimension, e.g., dimension 118 in the illustrated example. It should be appreciated that the downward title angle and the inward pan angle of each of the cameras 102, 104, 106, 108 may be independent of those of the other cameras 102, 104, 106, 108 (e.g., as dictated by the heights and/or other geometrical relationships of the respective cameras).

As illustrated in other drawings discussed in greater detail below, the cameras 102, 104, 106, 108 can be provided on rigid posts attached to the base 110 that fix their positions and orientations relative to the base 110 and the plane 112. Providing the cameras 102, 104, 106, 108 as fixedly coupled to the base 110 offers the advantage that the assisted checkout device 100 can be provided (e.g., shipped to a store) either as a single component that is already fully assembled or as a small number of components that are easily assembled, e.g., without special tools, training, or instructions, the structural assembly of which enforces desired or determined optimal camera placements and orientations that are unalterable during the regular course of checkout use, thus ensuring consistency of operation over the lifetime of the assisted checkout device 100.

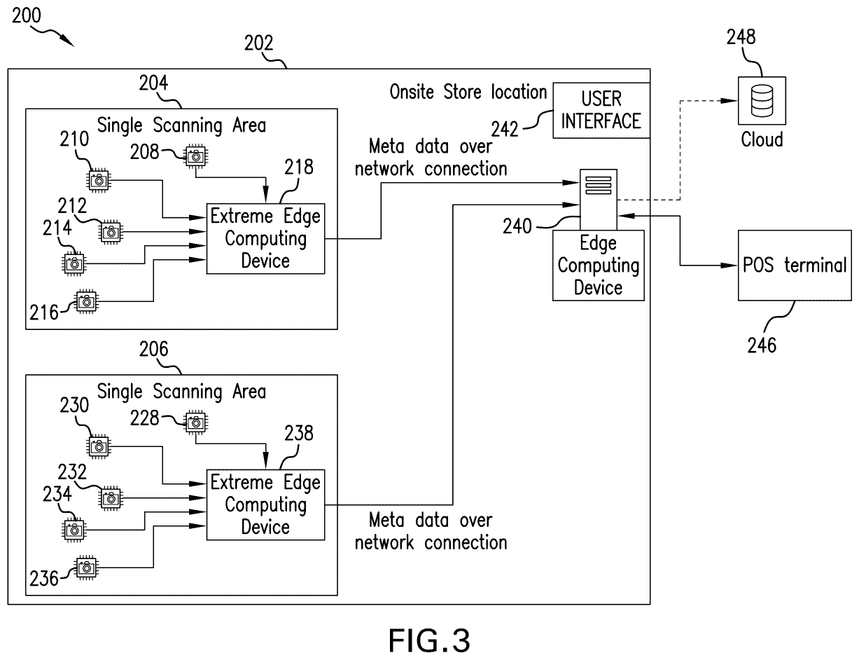

As described in greater detail below with respect to FIG. 3, each of the cameras 102, 104, 106, 108 (along with, in some examples, any other cameras associated with the assisted checkout station provided with assisted checkout device 108) can be wired or wirelessly coupled to a computing device, referred to herein as an extreme edge computing device, configured to receive and process video streams from the multiple cameras to which it is coupled. The extreme edge computing device runs software that provides a computer vision backend for the assisted checkout device 100, recognizing items placed on the checkout plane 112 as known items stored in a database of such items. Because this recognition is machine-vision-based, it does not require individual scanning of identifying markings (e.g., UPC barcodes) of the items placed for checkout. The backend generates, based on provided video stream inputs, a checkout list of items detected as placed on the checkout plane 112. In some examples, the extreme edge computing device (not shown in FIG. 2) can be concealed underneath a checkout counter on which the assisted checkout device 100 is placed, or in a nearby drawer or cabinet or other secure location. In other examples, the extreme edge computing device can be integrated into the base 110, or otherwise into some other part of the assisted checkout device 100.

The assisted checkout device 100 can also be provided with one or more visual displays (not shown in FIG. 2) that provide a frontend for the device 100. For example, the one or more visual displays can be coupled to the extreme edge computing device, or to another computing device that is, in turn, coupled to the extreme edge computing device. Each of the visual displays, for example, can be a tablet computing device having a touchscreen. The one or more visual displays collectively form a frontend for the assisted checkout device 100 that can be configured to display the checkout list generated by the backend. In some examples, the assisted checkout device 100 is provided with a first, customer-facing visual display and a second, cashier-facing visual display. The second, cashier-facing visual display can, in some examples, provide an interactive user interface (UI), e.g., a graphical user interface (GUI), permitting a cashier to add or remove items to or from the checkout list automatically generated by the backend. The first, customer-facing visual display can be equipped with payment acceptance functionality (e.g., a reader for a credit card or mobile phone) and can, in some examples, provide an interactive UI or GUI permitting a customer to tender cashless payment via the first visual display. In some examples, the temporal update rate of the revision of the checkout list on the frontend device(s) can be limited, e.g., to about 1 hertz.

### In-store Connectivity of Example Assisted Checkout Devices

FIG. 3 shows a block diagram of an example assisted checkout system 200 within a single store 202. The store 202 can have multiple assisted checkout stations 204, 206 each equipped with an assisted checkout device, such as the assisted checkout device 100 of FIG. 2. The example illustrated in FIG. 3 has two checkout stations 204, 206, but other examples can have more or fewer assisted checkout stations. Each assisted checkout station can include a number of cameras and an associated extreme edge computing device. In the illustrated example, a first extreme edge computing device 218 at the first assisted checkout station 204 is coupled to receive video streams from five cameras 208, 210, 212, 214, 216, and a second extreme edge computing device 238 at the second assisted checkout station 206 is coupled to receive video streams from five other cameras 228, 230, 232, 234, 236. For example, cameras 210, 212, 214, and 216 in FIG. 3 can correspond to cameras 102, 104, 106, and 108 in a first instance of the assisted checkout device 100 of FIG. 2, and camera 208 in FIG. 3 can correspond to a fifth (e.g., overhead) camera, not shown in FIG. 2, for the first assisted checkout station 204. Similarly, cameras 230, 232, 234, and 236 in FIG. 3 can correspond to cameras 102, 104, 106, and 108 in a second instance of the assisted checkout device 100 of FIG. 2, and camera 228 in FIG. 3 can correspond to a fifth (e.g., overhead) camera, not shown in FIG. 2, for the second assisted checkout station 206.

The cameras 208, 210, 212, 214, 216, 228, 230, 232, 234, and 236 can be coupled to their respective extreme edge computing devices 218, 238 using any suitable wired or wireless link or protocol. Providing the camera links as direct wired links, e.g., over USB, as opposed to indirect wired links or wireless links, e.g., over internet protocol (IP), has dependability and robustness advantages, in that each assisted checkout system need not be reliant on local area network (e.g., Wi-Fi) internet connectivity within the store 202, which may be slow, congested, or intermittent.

The extreme edge computing devices 218, 238 can each be any computing system capable of receiving and processing video streams from their respective cameras. In some examples, each extreme edge computing device 218, 238 is equipped with an AI acceleration unit, e.g., a graphics processing unit (GPU) or tensor processing unit (TPU), to provide the computing capability that may be required to process the video streams in accordance with computer vision methods described in greater detail below. In some embodiments, the extreme edge computing devices 218, 238 can include a complete computer system with an AI acceleration unit and a heat sink in a self-contained package. Provided with video streams from their respective video cameras, each extreme edge computing device 218, 238 derives and outputs metadata indicative of items detected on a checkout plane of a respective checkout station 204 or 206. In some examples, not shown in FIG. 3, a single extreme edge computing device can be coupled to the cameras from multiple (e.g., two) assisted checkout stations and can perform video stream receipt and processing functions for all of the multiple assisted checkout stations for which it is connected to cameras. The handling of multiple assisted checkout stations by a single extreme edge computing device reduces system costs and increases operational efficiency.

Each extreme edge computing device 218, 238 can, in turn, be wired or wirelessly coupled to another computing device 240 located on-site within the store 202, referred to herein as an edge computing device, e.g., over various network connections such as an Ethernet or Wi-Fi local area network (LAN) using an internet protocol. In some examples (not shown), the store 202 is provided with multiple edge computing devices 240. Each edge computing device 240 is likewise equipped with an AI acceleration unit (e.g., GPU or TPU) to provide the computing capability that may be required to train or re-train machine learning (ML) models as described in greater detail below. A POS terminal 246, or multiple such terminals, can be coupled to the edge computing device 240 (as shown) and/or to individual ones of the extreme edge computing devices 218, 238 (not shown). Each edge computing device 240 can communicate (e.g., over the internet) with remotely hosted computing systems 248 configured for distributed computation and data storage functions, referred to herein as the cloud.

The edge computing device 240 can configure and monitor the extreme edge computing devices 218, 238 to which it is connected to enable and maintain assisted checkout functionality at each assisted checkout station 204, 206. For example, the edge computing device 240 can treat the extreme edge computing devices 218, 238 as a distributed computing cluster managed, for example, using Kubernetes. An edge computing device in a store can thus provide a single point of contact for monitoring all of the extreme edge computing devices in the store, through which all of the edge computing devices can be managed, e.g., remotely managed over the cloud via a web-based configuration application. Advantageously, each store can be provided with at least two extreme edge computing devices 218, 238 to ensure checkout reliability through system redundancy. The edge computing device 240 can also receive data and metadata from the extreme edge computing devices 218, 238, enabling it to train or retrain ML models and thus improve assisted checkout functionality over time. In some examples, the edge computing device 240 and the extreme edge computing devices 218, 238 can be accessed and configured via a user interface (UI) 242, e.g., a graphical user interface (GUI), that can be accessible via a web browser.

In some examples, not shown in FIG. 3, one or more cameras associated with an assisted checkout station 204, 206 can connect directly to the edge computing device 240, rather than to the corresponding extreme edge computing device 218, 238. For example, an assisted checkout device at an assisted checkout station may have four USB cameras coupled to its associated extreme edge computing device, and a fifth (e.g., overhead) camera that is an IP camera that streams via wired or wireless connection to the store's edge computer device. In some examples, metadata derived from the video stream data from the fifth (IP) camera, generated at the edge computing device, can be merged at the edge computing device with metadata derived from the video stream data from the four USB cameras, generated at the extreme edge computing device associated with the checkout station, to provide an enhanced interpretation of the scene observed by all five cameras associated with the checkout station. The combination of AI-acceleration-unit-enabled extreme edge computing devices and an AI-acceleration-unit-enabled edge computing device can thus result in more efficient distribution of data processing tasks while simplifying infrastructure setup and maintenance and reducing network bandwidth that would otherwise be associated with streaming all assisted checkout camera outputs directly to an edge computing device over a local area network. Although described by way of example as connecting to another fifth (e.g., overhead) camera, it should be appreciated that many cameras may connect directly to the edge computing device 240 (e.g., some or all of the cameras in an existing security camera infrastructure) in some embodiments.

In some examples, the edge computing device 240 can be used to collect visual analytics information provided by a visual analytics system running on the edge computing device 240. The visual analytics information can include information about individual customer journeys through the store: paths taken through the store, items observed or interacted with (e.g., picked up), areas of interest entered (e.g., a coffee station, a beverage cooler, a checkout queue, a checkout station), and other gestures, behaviors, and activities observed. Advantageously, such information can be garnered from existing security camera infrastructure without using facial recognition or obtaining personally identifying information (PII) about the customers observed in the store. The edge computing device 240 can collate this video analytics information and combine it with information from the assisted checkout extreme edge computing devices 218, 238, such as checkout list predictions, to produce more accurate checkout list predictions on the edge computing device 240. In some examples, the video analytics information can be used for checkout, e.g., to produce a checkout list, without the use of an assisted checkout device 100.

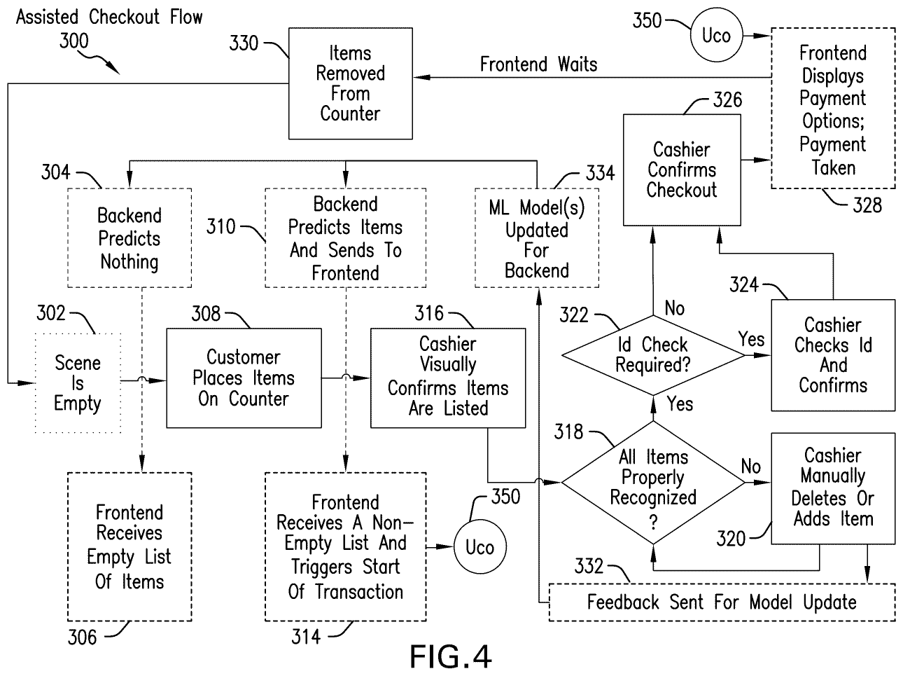

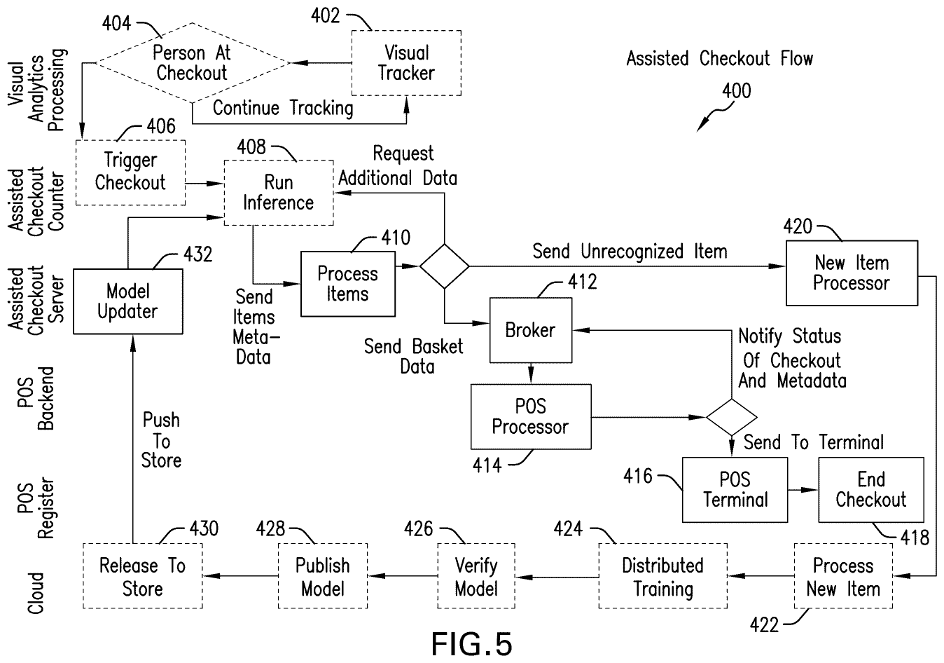

In some examples, inferencing using ML models, including those for detecting items and predicting what items appear in a scene, can be run on the extreme edge computing devices 218, 238, such that ML computational tasks are only offloaded to the edge computing device 240 for incremental training of ML models in real time. In the most frequent examples of operation of assisted checkout, each extreme edge computing device 218, 238 may send only generated metadata, rather than video streams or image data, to the edge computing device 242. The edge computing device 242 can be configured to maintain databases of items and sales, can communicate with the POS terminal 246, and can store feedback from the POS terminal 246. In some examples, each extreme edge computing device 218, 238 can operate generally to stream generated metadata unidirectionally to the edge computing device 240, by deriving still images from video streams and processing the still images to determine predictions regarding items in an observed scene over the checkout plane. ML learning, collection of feedback from cashiers, communicating with the POS, and storing of metadata can all take place on the edge computing device 242. As described in greater detail below with regard to FIGS. 4 and 5, feedback from the cashiers collected by the edge computing device 242 can, in some examples, be used to train ML models either on the edge computing device 242 or on the cloud. Newly trained or re-trained ML models can be provided from the edge computing device 242 back to the extreme edge computing devices 218, 238.

### Examples of Assisted Checkout Flow

FIG. 4 illustrates example functioning 300 of an assisted checkout device or system such as are respectively illustrated in FIGS. 2 and 3. The spatial volume over an assisted checkout plane (e.g., plane 112 in FIG. 2) of an assisted checkout station (e.g., station 204 or 206 in FIG. 3), as observed by associated cameras of a respective assisted checkout device (e.g., the device 100 of FIG. 2) is referred to herein as a scene. Initially, with no items placed on the assisted checkout plane, the scene is empty 302. The backend of the assisted checkout device therefore makes no predictions 304 as to the contents of the checkout list, and the frontend, as embodied, e.g., as one or more visual displays of the assisted checkout device, receives an empty list of items 306.

Subsequently, when a customer places items on the checkout counter 308, that is, on the checkout plane within view of the cameras of the assisted checkout device, the backend predicts the items placed on the checkout plane, generates a checkout list of the predicted items, and sends the generated checkout list to the frontend 310. The backend can also generate a quantification of confidence that the predicted checkout list is accurate and complete. For example, based on one or more items placed for checkout being recognized as observable by the assisted checkout device, but unidentifiable as particular items within the database of known items available for sale, the assisted checkout device can generate a low confidence indicator, which, in turn, can be used to generate an alert to the cashier. The alert can be displayed on the frontend, and/or can be indicated by lights on the assisted checkout device 100, e.g., built into the base or other portions of the assisted checkout device 100. For example, such lights could flash, or change color (e.g., from green to red), thereby alerting the cashier to an item recognition fault requiring manual intervention by the cashier.

Based on at least one presented item being successfully recognized as within the database, the frontend receives a non-empty list and triggers the start of a checkout transaction 314. At this point, any of several things can happen to complete the transaction. In some instances, a customer may begin the checkout process when the checkout station is initially unattended by a cashier. The assisted checkout device 100 may be enabled under certain conditions to complete the checkout process unattended. For example, based on (a) the backend of the assisted checkout device 100 reporting a confidence in the accuracy of the generated checkout list that exceeds a threshold, (b) the checkout list not including any items that require age verification (e.g., alcohol, nicotine, or lottery items), and (c) the customer indicating that payment is to be made without cash (e.g., by credit or debit card, or by using an electronic payment completed using a cellphone, or with a rewards card or certain coupons, or in accordance with a promotion) or cash handling equipment, the assisted checkout device 100 can proceed with unattended checkout (UCO) 350, if enabled to do so. With unattended checkout, the frontend of the assisted checkout device 100 displays payment options and takes payment 328. Although not shown in FIG. 4, payment information can be transmitted to a local database store. Having completed the checkout process, including the purchase transaction, the customer may then remove purchased items from the checkout counter 330 and leave the store.

Based on any of (a) the assisted checkout not being enabled for unassisted checkout, (b) the backing reporting a confidence in the accuracy of the checkout list that does not meet the threshold, (c) the checkout list containing items requiring age verification, (d) the customer not providing a cashless payment or otherwise indicating (e.g., through a GUI on the customer-facing visual display) that payment is to be made by cash or another method requiring cashier attendance, (d) a visual analytics system determining that the customer has one or more items not placed in the scene (e.g., a hot coffee or prepared food item, or an item that has been pocketed or otherwise concealed by the customer) or (e) the customer otherwise waiting for a cashier or indicating a need for help by the cashier, the checkout process may be continued as an attended checkout. If a cashier is not present at the assisted checked station, the cashier may be automatically alerted to attend the assisted checkout station. The cashier may then visually confirm that the generated checkout list (e.g., as displayed on a cashier-facing visual display) is accurate, e.g., that the checkout list contains no falsely recognized items and does not lack any unrecognized items or items that were not placed on the checkout plane.

In some examples, this confirmation by the cashier can be performed by the cashier looking at the list and looking at items placed on the checkout counter and/or withheld from the checkout counter by the customer, and comparing the list with the items presented for checkout on the checkout plane and/or withheld by the customer. In some examples, the assisted checkout device can provide, e.g., on a cashier-facing visual display monitor, a visual cue indicating which items placed on the checkout plane are unrecognized and thus are not entered on the checkout list. The visual cue can be, for example, a highlighting of the item in a video presentation derived from one or more of the cameras of the assisted checkout device. The highlighting can take the form of an adjusted brightness or contrast of the item in the video presentation, an outline or bounding box surrounding the item in the video presentation, or other form. The displayed visual cue can save the cashier time in determining which item or items on the checkout plane are unrecognized and require manual intervention to add to a checkout list. Any items not placed on the checkout plane (e.g., a cup of hot coffee preferred to be held by the customer and not placed on the checkout plane) can be scanned or otherwise entered for purchase either through the frontend or through a separate checkout system. Based on the cashier determining that all items in the scene have not been properly recognized and/or not all items presented for checkout have been listed on the checkout list 318, the cashier accordingly manually deletes or adds items to the list 320, e.g., using the GUI on the cashier-facing visual display.

In some examples, the manual deletion of falsely recognized items or the manual addition of unrecognized items can be performed by pressing quantity minus or quantity plus buttons on the GUI of the cashier-facing visual display. For example, if the checkout list erroneously includes an item confirmed by the cashier not to have been placed on the checkout plane, the cashier can locate the corresponding item on the list and press an associated quantity minus sign (−) button on the GUI to remove the item from the checkout list (or to decrement the number of identical items included on the checkout list). As another example, if the list erroneously includes too few of several identical items presented for checkout, the cashier can locate the corresponding item on the displayed checkout list and press an associated quantity plus sign (+) button to increment the number of identical items included on the checkout list.

In some examples, the cashier may manually intervene in the presentation of the items to the assisted checkout device, and may rearrange the items on the checkout plane to obtain a notably more accurate checkout list. For example, the cashier may spatially separate the items with respect to each other on the checkout plane, or may change the orientation of one or more items to give the cameras a better view of the items present for checkout.

In some examples, the cashier can manually scan one or more items presented for checkout to ensure their appearance on the checkout list. For example, the cashier can scan the one or more unidentified items using a UPC barcode reader or a QR code reader. Or, for example, a cashier may manually enter an identifying number for the item into the frontend or other system coupled to the assisted checkout device. In some examples, the cashier may hold the UPC barcode or QR code of an item, or other identifying marking of the item, up close to one of the cameras of the assisted checkout device, such that the item takes up a more substantial fraction of the field of view of the camera, prompting the assisted checkout device to perform an identification that is based on the UPC barcode or other identifying marking. Such identifying functionality may, for example, employ optical character recognition (OCR) to read a label of an item.

When a cashier manually enters an unrecognized item or otherwise manually adjusts a checkout list, manually entered information identifying the unrecognized item, images of the scene captured by the cameras during the checkout process, and/or metadata derived from the images can be automatically submitted 332 as system feedback data. The automatically submitted system feedback data can be used to retrain one or more ML models used by the backend to recognize items. The assisted checkout device, system of assisted checkout devices, and/or network of systems of assisted checkout devices at multiple stores can thereby learn information about the previously unrecognized item(s) and improve recognition of the items in future checkout transactions. Images or other data documenting manual overrides, such as the manually entered information identifying the unrecognized item, can be used for shrinkage reduction, e.g., theft, by a store employee or customer.

In some examples, an item may be placed on the checkout plane that is not a listed item for purchase, such as the customer's own wallet, keys, purse, or hand. Although the presence of such an item may reduce the checkout list accuracy confidence of the assisted checkout device 100 to a subthreshold value, and, in some circumstances may trigger an alert to the cashier, the cashier may exercise human discernment to safely ignore the non-inventory item presented, and confirm checkout 326.

Based on the cashier determining that all items presented for checkout have been properly recognized or manually entered 318 and are thus listed on the checkout list provided by the frontend, the cashier can then determine, e.g., based on an alert displayed on the cashier-facing visual display, whether an ID check is required 322 for any of the items presented for checkout. Based on no ID check being required for any of the items presented for checkout, the cashier can confirm the checkout 326, e.g., by pressing a “confirm” button or similar on the GUI of the cashier-facing visual display. In some examples, the assisted checkout system can interface with an automated age verification system to verify a person's age without human involvement, instead of having the cashier perform age verification. Based on an ID check being required for any of the items presented for checkout, the cashier can then ask the customer to present a valid identification document and confirm ID 324, e.g., by pressing an “ID confirmed” button or similar on the GUI of the cashier-facing display. The cashier can then proceed to confirm the checkout 326. The checkout having been confirmed, the frontend (e.g., a GUI of the customer-facing visual display) can display options for payment and, in some examples, can take payment 328. In examples in which a customer pays with cash, the cashier can take cash, make change, and use the frontend (e.g., a GUI of the cashier-facing visual display) to confirm payment. The attended checkout process is then complete, and the customer can remove the items from the checkout plane 330. The scene is then empty 302 again and the assisted checkout device thus can understand that when the scene next becomes non-empty 308, a new transaction has begun.

FIG. 5 illustrates a flow chart of example processes 400 of the assisted checkout flow, as described above with regard to FIG. 4, organized with regard to the systems used to handle the various aspects of the checkout flow. In some examples, a machine-vision-based storewide visual analytics system can operate using information from security cameras located around the store (that is, not one of the several cameras included as a part of the assisted checkout device) to track customers within the store and provide predictions as to the items picked up by a customer during the customer's journey throughout the store, which are expected to be presented for checkout. The visual analytics system can track the customer 402 and thus determine when the customer has entered certain areas of interest (AOIs) within the store, e.g., by mapping the three-dimensional location of the tracked customer to designated areas of the floor plan of the store. Such AOIs can include, as examples, a checkout queue or a checkout area. Information from the visual analytics system can be provided to the assisted checkout system (e.g., assisted checkout system 200 in FIG. 3). For example, the visual analytics system can be coupled to an edge computing device of the assisted checkout system (e.g., edge computing device 240 in FIG. 3). In some examples, the visual analytics system can share the same edge computing device as the assisted checkout system. Accordingly, the visual analytics system can inform the assisted checkout system when a person is detected to be at a checkout station 404. This information can trigger the start of a checkout transaction 406 without the use of an assisted checkout device, or can be used in conjunction with information derived from an assisted checkout device, detecting that items have been placed on a checkout plane of the assisted checkout device, to trigger the start of a checkout transaction 406. By combining information derived from the assisted checkout device and the visual analytics system, checkout triggering 406 can be made more accurate, false triggers of checkout processes can be reduced or avoided, and timing anticipation of checkouts can be made. For example, if a visual analytics system predicts, based on customer journey data, that a customer is likely proceeding to an unattended checkout station for checkout, an alert can be issued to a cashier advising attendance of the checkout station, even before the customer physically arrives at the checkout station.

The checkout process having been triggered 406, inferences are then run 408 using ML models on the backend of the assisted checkout device to attempt to recognize items placed on the checkout plane of an assisted checkout device. The inferences can be run 408, for example, on an extreme edge device of the assisted checkout device (e.g., extreme edge device 218 or 238 of FIG. 3). The inferences can, for example, use still image frames derived from video streams from cameras of the assisted checkout device to generate metadata indicative of recognized items placed on the checkout plane. As indicated in FIG. 5, the checkout trigger 406 and the inference running 408 can take place at the assisted checkout counter, that is, based on information determined at an extreme edge computing device coupled to the assisted checkout device.

In the example of FIG. 5, the metadata produced by the backend of the assisted checkout device can be provided to an assisted checkout server, e.g., edge computing device 240 in FIG. 3. The assisted checkout server can process the metadata 410 to recognize the items and can determine if additional data is needed, for example, if a cashier may be required to manually scan one or more unrecognized items. The inferences may be re-run 408 at the assisted checkout counter and the item metadata re-processed 410 at the assisted checkout server based on the provision of the requested additional data. The generated final list of checkout items and/or a checkout total (“basket data”) can be sent to a broker 412 at a point-of-sale (POS) backend. A POS processor 414 can receive input from the output of the broker 412 to process a tendered payment via an accepted method (e.g., a credit or debit card payment, or an e-payment made using a smartphone) using a POS terminal 416 at a POS register. The status of the checkout and the metadata can be provided back to the broker 412 at the POS backend in a feedback loop to ensure full payment is made, in some examples using multiple payment methods. The POS terminal 416 at the POS register receives the checkout total and accepts the payment method(s). The payment having been approved, the checkout transaction completes 418.

As discussed above with regard to FIG. 4, the assisted checkout system is capable of learning based on feedback from manual cashier intervention in the checkout process. For example, at the assisted checkout server, metadata about an unrecognized item can be sent to a new item processor 420 in the assisted checkout server. The new item processor can associate the metadata generated by ML inferencing 408 at the assisted checkout counter with manually provided item identification information. The metadata and the manually provided item identification information can be transmitted (e.g., over the internet) to the cloud system.

At the cloud, systems can process the new item 422 and conduct training or re-training of ML models, based on the feedback provided from the assisted checkout counter, using distributed computing 424 in the cloud. A newly trained or re-trained ML model can be manually or automatically verified 426, e.g., using established test data, to ensure, for example, that the newly trained or re-trained ML model does not have an unacceptably high error rate in recognizing products previously recognized accurately and with superthreshold confidence by previous versions of the ML model. The newly trained or re-trained model can then be published 428, e.g., by copying a model file containing the ML model to a location used for distribution. The newly trained or re-trained ML model is then released to the store (in some examples, to multiple stores) 430 using a push process, either immediately upon publication of the ML model or in accordance with an ML model push schedule. The assisted checkout server (the edge computing device) receives the pushed ML model from the cloud and updates the older version of the model stored at the assisted checkout counter (the extreme edge computing device) using a model updater 432 on the assisted checkout server. The model updater 432 on the assisted checkout server can, for example, perform checks to ensure that only newer versions of models replace older versions of models at the assisted checkout counter, and not vice-versa. The model updater 432 can also queue model updating to ensure that temporarily offline assisted checkout counter devices (extreme edge computing devices) eventually have their ML models updated upon coming back online. The feedback loop of boxes 408, 420, 422, 424, 426, 428, 430, and 432 permits the system to learn and improve. There may also be multiple appearances of a SKU (or UPC code), e.g., with new or holiday packaging of an item already existing in the item database. These items with different appearances may coexist at the store for a period of time. At some point, one of the item appearances may cease to exist. The system can handle multiple appearances and also can re-train the model and remove the old appearance with or without confirmation by a human operator. Although the ML models are described herein as being “pushed” to the various stores in the illustrative embodiment, it should be appreciated that the edge computing device may, additionally or alternatively, “pull” the current/updated ML models periodically according to a predefined schedule and/or occurrence of some condition in other embodiments.

The desirability and advantages of such a learning and improvement feedback loop used as online training, as described above with regard to FIGS. 4 and 5, is underscored considering the frequency of the introduction of new items, or the revision of item packaging, that could confuse the ML models upon which inferencing is run 408 at the assisted checkout counter, along with the onerousness and potential incompleteness associated with offline training. In offline training, ML models used by assisted checkout devices to visually recognize items are trained on new items or new item packaging outside of the sale process, e.g., using dedicated training time, staff, facilities, equipment, and item inventory. Apart from the undesirable added cost associated with offline training, relying on offline training may be slow to account for introductions for sale at stores of new items or new item packaging, resulting in a lag time between such an introduction and when the associated items can be successfully recognized by unassisted checkout devices. Moreover, offline training may fail to account for regional variations in items or item packaging, such that some stores never receive a model tailored for their particular item or item packaging variations.

Online training can be conducted at the assisted checkout server, or using the cloud, or both. Online training that employs the cloud can use training inputs derived from assisted checkout devices at multiple stores, e.g., many stores located across a geographic region (e.g., across a state, a country or across the world). Online training can therefore capable of obtaining a sufficient volume of training data in a shorter period of time than could be accomplished with offline training, at reduced training expense, because training resources (e.g., training staff and training data acquisition time) are not needed to accumulate the sufficient volume of training data necessary to newly train or re-train ML model. Such training data is passively acquired by the cloud in the course of normal sale use of assisted checkout systems in stores. Online training can further eliminate the administrative expense associated with specifically keeping track of, and notifying an ML model training staff of, new items and item packaging introduced in stores.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A system for automatically identifying a plurality of items positioned at a point of sale (POS) system based on a plurality of item parameters associated with each item as provided by a plurality of images captured by a plurality of cameras positioned at the POS system, comprising:
at least one processor;
a memory coupled with the at least one processor, the memory including instructions that, when executed by the at least one processor cause the at least one processor to:
extract a plurality of Universal Product Code (UPC) features included in a plurality of item parameters associated with each item positioned on the POS system from the plurality of images captured of each item by the plurality of cameras positioned at the POS system, wherein the UPC features associated with each item when combined are indicative as to an identification of the UPC of each item,
analyze the UPC features associated with each item positioned at the POS system to determine whether the UPC features associated with each item when combined matches a corresponding combination of the UPC features stored in an item parameter identification database, wherein the item parameter identification database stores different combinations of UPC features with each different combination of UPC features associated with a corresponding item thereby identifying each corresponding item based on each different combination of UPC features associated with each item, and
identify each corresponding item positioned at the POS system when the UPC features associated with each item when combined match a corresponding combination of UPC features as stored in the item parameter identification database.

2. The system of claim 1, wherein the processor is further configured to:
extract the plurality of item parameters associated with each item positioned at the POS system from the plurality of images captured of each item by the plurality of cameras positioned at the POS system, wherein the item parameters associated with each item when combined with the extracted UPC features associated with each item are indicative as to the identification of each corresponding item thereby enabling the identification of each corresponding item.

3. The system of claim 2, wherein the processor is further configured to:
analyze the item parameters associated with each item positioned at the POS system in combination with the UPC features associated with each item positioned at the POS system to determine whether the item parameters when combined with the combination of UPC features matches a corresponding combination of the item parameters stored in the item parameter identification database, wherein the item parameter identification database stores different combinations of item parameters with different combinations of UPC features with each different combination of item parameters when combined with each different combination of UPC features are associated with a corresponding item thereby identifying each corresponding item based on each different combination of item parameters when combined with each different combination of UPC features.

4. The system of claim 3, wherein the processor is further configured to:
identify each corresponding item positioned at the POS system when the item parameters associated with each item when combined with the UPC features associated with each item match a corresponding combination of item parameters and UPC features as stored in the item parameter identification database.

5. The system of claim 1, wherein the processor is further configured to:
extract a plurality of text features from the plurality of images captured of each item by the plurality of cameras positioned at the POS system that includes a plurality of digits and a barcode of each UPC of each item positioned at the POS, wherein the digits of each UPC and the barcode of each UPC captures from the plurality of images of each item is partial digits of each UPC and the barcode of each UPC captured from the plurality of images of each item is a partial barcode of each UPC.

6. The system of claim 5, wherein the processor is further configured to:
compare the partial digits of each UPC and the partial barcode of each UPC as captured from the images of each item to a complete set of digits and a complete barcode of each UPC associated with each item stored in the item parameter identification database, wherein the item parameter identification database stores the complete set of digits and the complete barcode of each UPC associated with each item;
determine whether the partial digits of each UPC and the partial barcode of each UPC as captured from the images of each item when combined matches a corresponding combination of digits and barcode included in the complete set of digits and the complete barcode of each UPC as stored in the item parameter identification database; and
identify each corresponding item positioned at the POS system when the partial digits of each UPC and the partial barcode of each UPC when combined match a corresponding combination of digits and barcode included in the complete set of digits and the complete barcode of each UPC as stored in the item parameter identification database.

7. The system of claim 6, wherein the processor is further configured to:
determine a location of the partial digits of each UPC as captured from the images of each item as positioned relative to the complete set of digits of each UPC and a location of the partial barcode of each UPC as captured from the images of each item as positioned relative to the complete barcode of each UPC;
determine whether the location of the partial digits of each UPC and the location of the partial barcode of each UPC when combined matches a corresponding location of digits and barcode included in the complete set of digits and the complete barcode of each UPC as stored in the item parameter identification database; and
identify each corresponding item positioned at the POS system when the location of the partial digits of each UPC and the location of the partial barcode of each UPC when combined match a corresponding location of digits and location of barcode included in the complete set of digits and the complete barcode of each UPC as stored in the item parameter identification database.

8. The system of claim 1, wherein the processor is further configured to:
receive a plurality of images of the UPC features of each item positioned on the POS system by a plurality of cameras positioned at the UPC system, wherein each different image captured by each different camera captures a different set of UPC features of each item positioned at the UPC system; and
extract each different set of UPC features from each different image captured by each different camera, wherein each different set of UPC features captured by each different camera is a different image clip of UPC features depicting different partial features of each corresponding UPC associated with each item positioned on the POS system.

9. The system of claim 8, wherein the processor is further configured to:
fuse each different set of UPC features from each different image clip of UPC features depicting different partial features of each UPC associated with each item as extracted from each different image captured by each different camera of the UPC features of each item positioned on the POS system, wherein each different set of UPC features from each different image clip of UPC features depicting different partial features of each UPC when fused together depict an increased set of UPC features of each UPC associated with each item.

10. The system of claim 9, wherein the processor is further configured to:
compare each fused set of UPC features from each different image clip of UPC features of each UPC to a complete set of UPC features of each UPC associated with each item stored in the item parameter identification database, wherein the item parameter identification database stores the complete set of UPC features of each UPC associated with each item;
determine whether each fused set of UPC features from each different image clip of UPC features of each UPC when combined matches a corresponding set of UPC features in the complete set of UPC features of each UPC as stored in the item parameter identification database; and
identify each corresponding item positioned at the POS system when each fused set of UPC features from each different image clip of UPC features of each UPC when combined match a corresponding set of UPC features in the complete set of UPC features of each UPC as stored in the item parameter identification database.

11. A method for automatically identifying a plurality of items positioned at a point of sale (POS) system based on a plurality of item parameters associated with each item as provided by a plurality of images captured by a plurality of cameras positioned at the POS system, comprising:
extracting a plurality of Universal Product Code (UPC) features included in a plurality of item parameters associated with each item positioned on the POS system from the plurality of images captured of each item by the plurality of cameras positioned at the POS system, wherein the UPC features associated with each item when combined are indicative as to an identification of the UPC of each item;
analyzing the UPC features associated with each item positioned at the POS system to determine whether the UPC features associated with each item when combined matches a corresponding combination of the UPC features stored in an item parameter identification database, wherein the item parameter identification database stores different combinations of UPC features with each different combination of UPC features associated with a corresponding item thereby identifying each corresponding item based on each different combination of UPC features associated with each item; and
identifying each corresponding item positioned at the POS system when the UPC features associated with each item when combined match a corresponding combination of UPC features as stored in the item parameter identification database.

12. The method of claim 11, wherein the extracting further comprises:
extracting the plurality of item parameters associated with each item positioned at the POS system from the plurality of images captured of each item by the plurality of cameras positioned at the POS system, wherein the item parameters associated with each item when combined with the extracted UPC features associated with each item are indicative as to the identification of each corresponding item thereby enabling the identification of each corresponding item.

13. The method of claim 12, further comprising:
analyzing the item parameters associated with each item positioned at the POS system in combination with the UPC features associated with each item positioned at the POS system to determine whether the item parameters when combined with the combination of UPC features matches a corresponding combination of the item parameters stored in the item parameter identification database, wherein the item parameter identification database stores different combinations of item parameters with different combinations of UPC features with each different combination of item parameters when combined with each different combination of UPC features are associated with a corresponding item thereby identifying each corresponding item based on each different combination of item parameters when combined with each different combination of UPC features.

14. The method of claim 13, further comprising:
identifying each corresponding item positioned at the POS system when the item parameters associated with each item when combined with the UPC features associated with each item match a corresponding combination of item parameters and UPC features as stored in the item parameter identification database.

15. The method of claim 11, further comprising:
extracting a plurality of text features from the plurality of images captured of each item by the plurality of cameras positioned at the POS system that includes a plurality of digits and a barcode of each UPC of each item positioned at the POS, wherein the digits of each UPC and the barcode of each UPC captured from the plurality of images of each item is partial digits of each UPC and the barcode of each UPC captured from the plurality of images of each item is a partial barcode of each UPC.

16. The method of claim 15, further comprising:
comparing the partial digits of each UPC and the partial barcode of each UPC as captured from the images of each item to a complete set of digits and a complete barcode of each UPC associated with each item stored in the item parameter identification database, wherein the item parameter identification database stores the complete set of digits and the complete barcode of each UPC associated with each item;
determining whether the partial digits of each UPC and the partial barcode of each UPC as captured from the images of each item when combined matches a corresponding combination of digits and barcode included in the complete set of digits and the complete barcode of each UPC as stored in the item parameter identification database; and
identifying each corresponding item positioned at the POS system when the partial digits of each UPC and the partial barcode of each UPC when combined match a corresponding combination of digits and barcode included in the complete set of digits and the complete barcode of each UPC as stored in the item parameter identification database.

17. The method of claim 16, further comprising:
determining a location of the partial digits of each UPC as captured from the images of each item as positioned relative to the complete set of digits of each UPC and a location of the partial barcode of each UPC as captured from the images of each item as positioned relative to the complete barcode of each UPC;
determining whether the location of the partial digits of each UPC and the location of the partial barcode of each UPC when combined matches a corresponding location of digits and barcode included in the complete set of digits and the complete barcode of each UPC as stored in the item parameter identification database; and
identifying each corresponding item positioned at the POS system when the location of the partial digits of each UPC and the location of the partial barcode of each UPC when combined match a corresponding location of digits and location of barcode included in the complete set of digits and the complete barcode of each UPC as stored in the item parameter identification database.

18. The method of claim 11, further comprising:
receiving a plurality of images of the UPC features of each item positioned on the POS system by a plurality of cameras positioned at the UPC system, wherein each different image captured by each different camera captures a different set of UPC features of each item positioned at the UPC system; and
extracting each different set of UPC features from each different image captured by each different camera, wherein each different set of UPC features captured by each different camera is a different image clip of UPC features depicting different partial features of each corresponding UPC associated with each item positioned on the POS system.

19. The method of claim 18, further comprising:
fusing each different set of UPC features from each different image clip of UPC features depicting different partial features of each UPC associated with each item as extracted from each different image captured by each different camera of the UPC features of each item positioned on the POS system, wherein each different set of UPC features from each different image clip of UPC features depicting different partial features of each UPC when fused together depict an increased set of UPC features of each UPC associated with each item.

20. The method of claim 19, further comprising:
comparing each fused set of UPC features from each different image clip of UPC features of each UPC to a complete set of UPC features of each UPC associated with each item stored in the item parameter identification database, wherein the item parameter identification database stores the complete set of UPC features of each UPC associated with each item;
determining whether each fused set of UPC features from each different image clip of UPC features of each UPC when combined matches a corresponding set of UPC features in the complete set of UPC features of each UPC as stored in the item parameter identification database; and
identifying each corresponding item positioned at the POS system when each fused set of UPC features from each different image clip of UPC features of each UPC when combined match a corresponding set of UPC features in the complete set of UPC features of each UPC as stored in the item parameter identification database.
